(19) United States
(12) Patent Application Publication
(10) Pub. No.: US 2014/0337051 A1
(43) Pub. Date: Nov. 13, 2014

(54) Apparatus for and method of using an electronic medical records (EMR) system

(71) Applicant: Ronald Steven Karpf, Corvallis, OR (US)

(72) Inventors: Ronald Steven Karpf, Corvallis, OR (US); Arthur Beau White, Kensington, MD (US)

(21) Appl. No.: 13/986,525

(22) Filed: May 13, 2013

(51) Int. Cl. G06F 19/00

(52) U.S. Cl. CPC G06F 19/322
USPC 705/3

(57) ABSTRACT

In accordance with a preferred embodiment of the invention, medical personnel may enter into an electronic medical records (EMR) storage mechanism the precise treatment instructions issued to a patient. A database is accessible to the patient to allow the patient to review the patient's records, including the exact treatment instructions. The most current recommended diagnosis specific treatment guidelines, for example, may be provided to the medical practitioner as a starting point in specifying the treatment instructions. Patients may customize the manner in which the exemplary system interacts with the patients. Patients may also specify the mechanism by which they will receive compliance reminder messages. The patient may also restrict access to the patient's records, even by medical personnel, in accordance with a preferred embodiment of the invention.

This application is a divisional of U.S. patent application Ser. No. 11/645,067, filed on Dec. 26, 2006, which is Continuation of U.S. patent application Ser. No. 11/074,053, filed on Mar. 8, 2005, which is a Continuation of U.S. patent application Ser. No. 09/372,955, filed on Aug. 12, 1999, now U.S. Pat. No. 7,287,031. The entire contents of each of the above applications are being herein incorporated by reference for all purposes.

### BACKGROUND

There is a significant problem with patients' failing to follow a medical practitioners post-examination treatment instructions. The terminology used for this is compliance. While the patient may choose to consciously ignore medically necessary advice, the greater problem is with patients who leave the medical practitioners office without being sufficiently cognizant of the diagnosis or prepared to follow the recommended therapeutic intervention. This long recognized problem has been intractable, defying easy solution, but which can now be addressed due to advances in telecommunications and computer technology.

Often, even physicians do not comply with the American Diabetes Association (ADA) standards of practice. It is well documented that physicians and other health care providers often do not comply with the existing ADA guidelines. And even when the health care provider strictly adheres to the recommended disease specific intervention, the patient is likely to depart from the recommended therapy either through neglect or misunderstanding.

### SUMMARY

In accordance with a preferred embodiment of the invention, medical personnel may enter into an electronic medical records (EMR) storage mechanism, which in a preferred embodiment takes the exemplary form of a treatment instructions database, at the time of the examination, the precise treatment instructions that the doctor issues to the patient. In the exemplary system, the treatment instructions database is accessible to the patient to allow the patient, at any time subsequent to the examination, to review the patient's records, including the exact treatment instructions that have been provided to the patient by the medical practitioner.

Treatment instructions include both the therapeutic regimen (e.g., medical prescriptions) as well as information about the disease and treatment, since a patient who understands the disease and treatment is more likely to be compliant. To aid the medical practitioner to enter the therapeutic regimen, source materials are provided. The most current recommended diagnosis specific treatment guidelines are provided as a starting point in specifying the treatment instructions. The medical practitioner is not restricted to the use of the available treatment guidelines but may modify them in part or full. Other types of treatment instructions include disease and treatment information, alerts and recommended followup.

To maximize the usability of the system by patients, patients may customize the manner in which the exemplary system interacts with the patients. The patient may, for example, specify preferences such as a language preference. Since much of the information that is presented is from suggested treatment guidelines and up-to-date information sources, this information can be presented in a language of their choice. Patients may also specify the mechanism by which they will receive compliance reminder messages. A compliance reminder message may be sent to a patient who has not accessed the treatment information. The patient may also restrict access to the patient's records, even by medical personnel, in accordance with a preferred embodiment of the invention.

Other objects and advantages of the invention will be set forth in part in the description that follows and in part will be obvious from the description or may be learned by practice of the invention. The objects and advantages of the invention will be realized and attained by means of the elements and combinations particularly pointed out in the appended claims.

### BRIEF DESCRIPTION OF THE DRAWINGS

The accompanying drawings, which are incorporated in and constitute a part of the specification, illustrate a preferred embodiment of the invention, and together with the detailed description of a preferred embodiment, serve to illustrate some of the principles of the invention.

FIG. 1 is a block diagram of an exemplary system in accordance with a preferred embodiment of the invention.

FIG. 2 is a block diagram of the computers used in the exemplary system.

FIG. 3 is an entity-relationship diagram of the treatment instructions database of the exemplary system.

FIG. 4 is a decision matrix for assigning a measure of compliance to a patient as used in the exemplary system in accordance with a preferred embodiment of the invention.

FIG. 5 is an example of the user-interface logon screen of the patient program as used in the exemplary system in accordance with a preferred embodiment of the invention.

FIG. 6 is an example of the user-interface logon screen of the exemplary patient program with all sections of the user-interface expanded.

FIG. 7 is an example of the user-interface screen of the exemplary patient program showing the patient's office visits.

FIG. 8 is an example of the user-interface screen of the exemplary patient program showing the treatment instructions for a selected office visit.

FIG. 9 is an example of the user-interface logon screen of the medical personnel data entry program as used in the exemplary system in accordance with a preferred embodiment of the invention.

FIG. 10 is an example of the user-interface screen of the medical personnel data entry program showing the medical personnel registration section.

FIG. 11 is an example of the user-interface of the exemplary medical personnel data entry program used to enter the identity of the patient.

FIG. 12 is an example of the user-interface of the exemplary medical personnel data entry program used to enter the patient diagnosis and treatment instructions.

FIG. 13 is an example of the user-interface logon screen of the medical personnel administration program as used in the exemplary system in accordance with a preferred embodiment of the invention.

FIG. 14 is and example of the user-interface of the exemplary medical personnel administration program showing the list of all patients, by visit, who have been seen by the designated medical personnel.

FIG. 15 is an example of the user-interface of the exemplary medical personnel administration program showing status of the treatment instructions for a patient visit.

FIG. 16 is an example of a compliance reminder message sent via Email to a patient in the exemplary system.

FIG. 17 is a state diagram describing the operation of the exemplary patient program in accordance with a preferred embodiment of the invention.

FIG. 18A is a state table describing the operation of the exemplary patient program in accordance with a preferred embodiment of the invention.

FIG. 18B is a continuation of the state table describing the operation of the exemplary patient program in accordance with a preferred embodiment of the invention.

FIG. 19 is a state diagram describing the operation of the exemplary medical personnel data entry program in accordance with a preferred embodiment of the invention.

FIG. 20A is a state table describing the operation of the exemplary medical personnel data entry program in accordance with a preferred embodiment of the invention.

FIG. 20B is a continuation of the state table describing the operation of the exemplary medical personnel data entry program in accordance with a preferred embodiment of the invention.

FIG. 20C is a continuation of the state table describing the operation of the exemplary medical personnel data entry program in accordance with a preferred embodiment of the invention.

FIG. 21 is a state diagram describing the operation of the exemplary medical personnel administration program in accordance with a preferred embodiment of the invention.

FIG. 22A is a state table describing the operation of the exemplary medical personnel administration program in accordance with a preferred embodiment of the invention.

FIG. 22B is a continuation of the state table describing the operation of the exemplary medical personnel administration program in accordance with a preferred embodiment of the invention.

FIG. 23 is a state diagram describing the operation of the treatment instructions server program as used in the exemplary system in accordance with a preferred embodiment of the invention in accordance with a preferred embodiment of the invention.

FIG. 24A is a state table describing the operation of the exemplary treatment instructions server program in accordance with a preferred embodiment of the invention.

FIG. 24B is a continuation of the state table describing the operation of the exemplary treatment instructions server program in accordance with a preferred embodiment of the invention.

FIG. 24C is a continuation of the state table describing the operation of the exemplary treatment instructions server program in accordance with a preferred embodiment of the invention.

FIG. 24D is a continuation of the state table describing the operation of the exemplary treatment instructions server program in accordance with a preferred embodiment of the invention.

FIG. 24E is a continuation of the state table describing the operation of the exemplary treatment instructions server program in accordance with a preferred embodiment of the invention.

FIG. 24F is a continuation of the state table describing the operation of the exemplary treatment instructions server program in accordance with a preferred embodiment of the invention.

FIG. 24G is a continuation of the state table describing the operation of the exemplary treatment instructions server program in accordance with a preferred embodiment of the invention.

### DETAILED DESCRIPTION OF A PREFERRED EMBODIMENT

References will now be made in detail to a preferred embodiments of the invention, examples of which are illustrated in the accompanying drawings. Wherever possible, the same reference numbers will be used throughout the drawings to refer to the same or like parts.

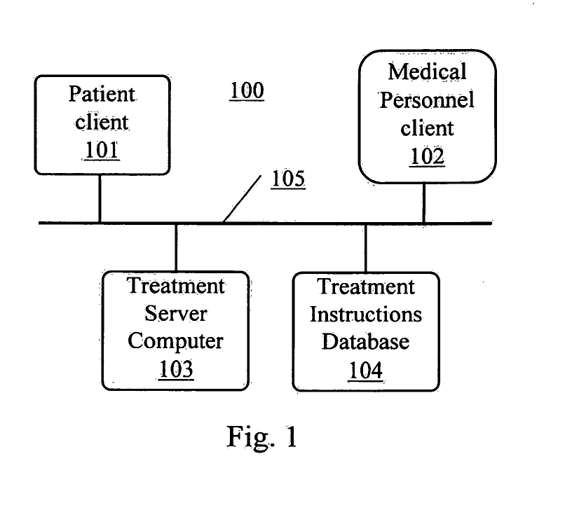

FIG. 1 is a block diagram of an exemplary Electronic Medical Records (EMR) system in accordance with a preferred embodiment of the invention. In the exemplary system, a system 100 of FIG. 1 illustrates the patient-client computer 101, the medical personnel-client computer 102, the treatment server computer 103, an EMR database in the exemplary form of treatment instructions database 104, and the network interface 105 over which they establish a connection and communicate. In a preferred embodiment, the network interface protocol that is used is the industry standard network protocol TCP/IP.

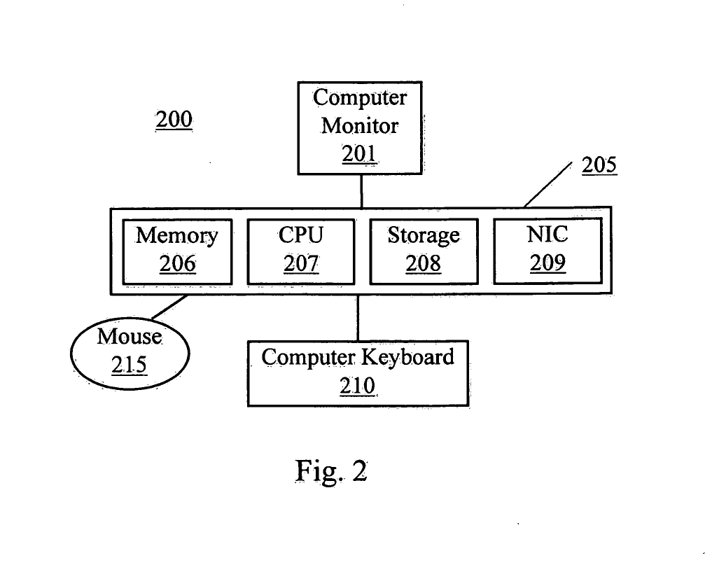

FIG. 2 is a block diagram of the computers used in the exemplary system. In a preferred embodiment, the same computer hardware was used for the patient-client computer 101, the medical personnel-client computer 102, and the treatment server computer 103.

In a preferred embodiment, the exemplary system 200 consists of a computer monitor 201, computer 205, computer mouse 215, and a computer keyboard 210. The computer 205 includes a memory 206 and a processor (CPU) 207, a mass storage device 208, and a network interface card (NIC) 209. Monitor 201, the computer mouse 215, and computer keyboard 210, are connected to computer 205 in a manner known to persons of ordinary skill in the art.

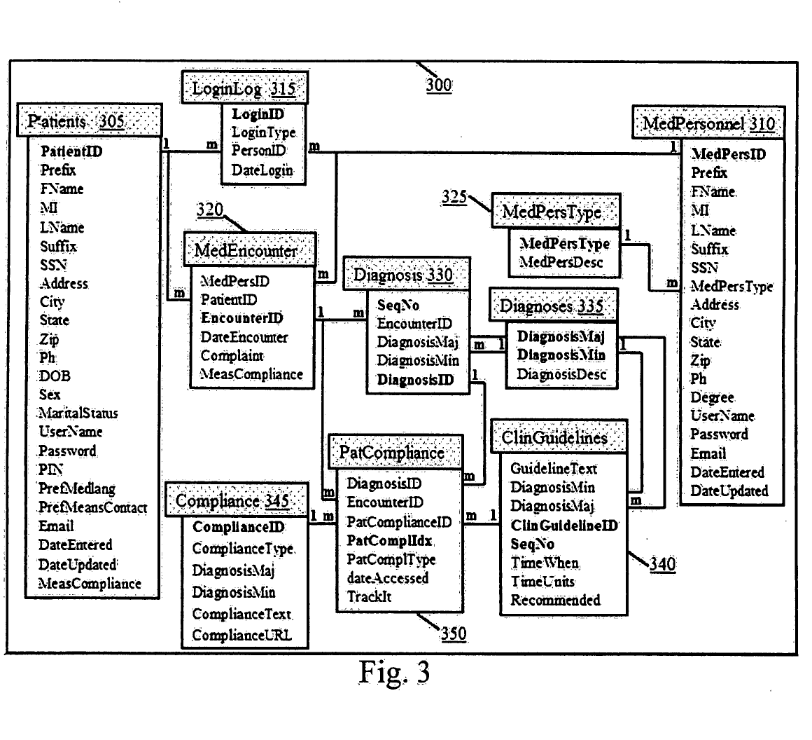

FIG. 3 shows an entity-relationship or ER diagram 300 of the exemplary treatment instruction database 104 as used in the exemplary system in accordance with a preferred embodiment of the invention. It shows the 10 relational tables that comprise the treatment instructions database, the fields of each table, the primary key of each table and the primary-foreign key relationship between fields of different tables. The discussion below also provides the attributes of each field of every table. On the figure, the primary key field is highlighted in bold print. Relationship lines drawn between the tables identify primary-foreign key relationships between the tables. The label ‘1’ and ‘m’ on either side of the relationship line indicates that tables have a one-to-many relationship, with many records on the ‘m’ associated table possibly existing for each unique row of the ‘1’ associated table.

Table ‘Patients’ 305 contains a single record with information about every patient that is registered to use the exemplary system. The primary key, ‘PatientID’, may be a unique long integer. The other fields of table ‘Patients’ 305 include the patients name stored in the fields ‘Prefix’ a text field of length 8 with the title of a patient such as ‘Mr.’ or ‘Mrs.’; ‘FName’ a text field of length 24 with the first name of the patient; ‘MI’ a text field of length 1 with the middle initial of the patient; ‘LName’ a text field of length 24 with the last name of the patient; and ‘Suffix’ a text field of length 8 with a name suffix such as ‘Ph.D’, or ‘MD’. Still other fields of table ‘Patients’ 305 include patient identifiers or other demographics stored in the fields ‘SSN’ a text field of length 11 with the social security number of the patient; ‘DOB’ a date field with the date of birth of the patient; ‘Sex’ a text field of length one with either ‘M’ or ‘F’ for ‘Male’ or ‘Female’; ‘MaritalStatus’ a field of length 1 with the marital status of the patient coded as ‘S’, ‘M’, ‘D’, or ‘W’ for ‘Single’, ‘Married’, ‘Divorced’, or ‘Widowed’ respectively. Other fields of table ‘Patients’ 305 store the address of the patient in fields ‘Address’ a text field of length 50 with the address of the patient; ‘City’ a text field of length 24 with the home city of the patient; ‘State’ a text field of length 2 with the 2 character postal abbreviation of the home state of the patient; ‘Zip’ a text field of length 10 with the postal zip code of the patient, and ‘Ph’ a text field of length 12 with the area code and phone number of the patient. Other fields of table ‘Patients’ 305 store the Username and Password of the patient in fields ‘Username’ a text field of length 24 with the Username of the patient; ‘Password’ a text field of length 24 with the Password of the patient, and ‘PIN’ a text field of length 24 with the patient's Password that is used by authorized medical personnel to identify the patient for data entry of the treatment instructions. The remaining fields of table ‘Patients’ 305 are ‘PrefMedLang’ a text field of length 8 used to store the patients language preference for reviewing treatment instructions; ‘PrefMeansContact’ a text field of length 8 used to store the means by which a patient prefers to receive reminder compliance messages; ‘DateEntered’ a date field with a date and time stamp for when the patient registered with the exemplary system; ‘DateUpdated’ field with the date attribute with a date and time stamp for when the patient last updated the registration information, ‘Email’ a text field of length 124 with the Email address of the patient, and ‘MeasCompliance a text field of length 24 with the patient's overall measure of compliance. When the patient first registers the ‘DateEntered’ and ‘DateUpdated’ are set to the same value.

Table ‘MedPersonnel’ 310 contains a single record with information about every medical practitioner that is registered to use the exemplary system. The primary key, ‘MedPersID’, may be a unique long integer. The other fields of table ‘MedPersonnel’ 310 include the name stored in the fields ‘Prefix’ a text field of length 8 with the title of a patient such as ‘Dr.’ or ‘Mr’; ‘FName’ a text field of length 24 with the first name of the medical personnel; ‘MI’ a text field of length ‘1’ with the middle initial of the medical personnel; ‘LName’ a text field of length 24 with the last name of the medical personnel; and ‘Suffix’ a text field of length 8 with a name suffix such as ‘Ph.D’, or ‘MD’. A social security number identifier for the medical personnel is stored in field ‘SSN’ a text field of length 11, and their educational level of attainment or educational degree is stored in the field ‘Degree’ a text field of length 8. The field ‘MedPersType’ of table ‘MedPersonnel’ 310 has a many-to-one primary-foreign key relationship with the field ‘MedPersType’ of table ‘MedPersType’ 325 and has the same attributes. Medical personnel logon validation are stored in fields ‘Username’ a text field of length 24 with the Usemame of the medical personnel, and ‘Password’ a text field of length 24 with the Password of the medical personnel. The remaining fields of table ‘MedPersonnel’ 310 are ‘DateEntered’ a date field with a date and time stamp for when the medical personnel registered with the exemplary system; ‘DateUpdated’ field with the date attribute with a date and time stamp for when the medical personnel last updated the registration information, and ‘Email’ a text field of length 124 with the Email address of the medical personnel. Other fields of table ‘MedPersonnel’ 310 store the address of the patient in fields ‘Address’ a text field of length 50 with the work address of the medical personnel; ‘City’ a text field of length 24 with the work city of the medical personnel; ‘State’ a text field of length 2 with the 2 character postal abbreviation of the work state of the medical personnel; ‘Zip’ a text field of length 10 with the postal zip code of the medical personnel, and ‘Ph’ a text field of length 12 with the area code and phone number of the medical personnel.

Table ‘LoginLog’ 315 contains information that is an audit record or log of all users that successfully access the exemplary system with a valid Username and Password. The primary key, ‘LoginID’ may be a unique long integer. The other fields of table ‘LoginLog’ 315 include ‘LoginType’, a field of length 8 with an encoding of the category of person who has successfully logged onto the exemplary system, and its valid entries are ‘patient’ for a patient using the exemplary patient program to view their treatment instructions, ‘medpers’ for medical personnel using the exemplary medical personnel data entry program, and ‘admin’ for medical personnel using the exemplary medical personnel administration program. The field ‘DateLogin’ is a date field with the date and time that the user logged onto the exemplary system. If the value of the field ‘LoginType’ is ‘patient’ then the field ‘PersonID’ of table ‘LoginLog’ 315 has a many-to-one primary-foreign key relationship with the field ‘PatientID’ of table ‘Patients’ 305 and has the same attributes. If the value of the field ‘LoginType’ is ‘medpers’ or ‘admin’ then the field ‘PersonID’ of table ‘LoginLog’ 315 has a many-to-one primary-foreign key relationship with the field ‘MedPersID’ of table ‘MedPersonnel’ 310 and has the same attributes.

Table ‘MedEncounter’ 320 contains a single record with information about every medical encounter or office visit between a patient and a medical practitioner. The primary key, ‘EncounterID’, may be a unique long integer. The field ‘MedPersID’ of table ‘MedEncounter’ 320 has a many-to-one primary-foreign key relationship with the field ‘MedPersID’ of table ‘MedPersonnel’ 310 and has the same attributes. The field ‘PatientID’ of table ‘MedEncounter’ 320 has a many-to-one primary-foreign key relationship with the field ‘PatientID’ of table ‘Patients’ 305 and has the same attributes. The other fields of this table form a history of problems associated with a patient, including ‘DateEncounter’ which has a date attribute and contains the problem onset date or date of the medical encounter; ‘Complaint’ a text field of length 255 with the patients complaint or reason for the medical appointment, and ‘MeasCompliance’ a text field of length 24 with the exemplary system calculated patient measure of compliance for the associated medical visit.

Table ‘MedPersType’ 325 is a lookup table that has a single record for every category of medical personnel describing the type of medical personnel. The primary key ‘MedPersType’, is an integer field and is a numeric coding of a unique type of medical personnel. The field ‘MedPersDesc’ is a text field of length 50 that has a description of the type of medical personnel corresponding to the value in the primary key field ‘MedPersType’. For instance, the record with a value of ‘1’ for ‘MedPersType’ has a corresponding record value of ‘Dr.’ for the ‘MedPersDesc’ field.

Table ‘Diagnosis’ 330 contains information about the health condition (or “diagnosis”) as determined by a medical practitioner of the patients complaint or reason for the office visit. The field ‘DiagnosisID’ may be a unique long integer. The primary key is the composite index formed by ‘DiagnosisID’ and ‘SeqNo’. The field ‘EncounterID’ of table ‘Diagnosis’ 330 has a many-to-one primary-foreign key relationship with the field ‘EncounterID’ of table ‘MedEncounter’ 320 and has the same attributes. Any medical encounter can result in several different diagnoses so there may be several records in this table for a single patient medical encounter distinguished by a SeqNo starting with ‘1’ and incrementing by ‘1’. The combination of field ‘DiaignosisID’ and ‘SeqNo’ provides a unique identifier for an individual diagnosis. The fields ‘DiagnosisMaj’ and ‘DiagnosisMin’ of table ‘Diagnosis’ 330 have a many-to-one primary-foreign key relationship with the fields ‘DiagnosisMaj’ and ‘DiagnosisMin’ of table ‘Diagnoses’ 335 and have the same attributes.

Table ‘Diagnoses’ 335 contains information categorizing different diagnoses. Each diagnosis has a major and minor category coding. For instance Diabetes would be a major diagnoses category and each of the different types of Diabetes would be coded in the minor category coding. The primary key for this table is a composite index of two fields ‘DiagnosisMaj’ and ‘DiagnosisMin’ and each is a text field of length 16. The field ‘DiagnosisDesc’ is a text field of length 255 with a text description of the diagnosis record.

Table ‘ClinGuidelines’ 340 contains information about the recommended clinical therapeutic guideline for a diagnoses. The other standard compliance information is contained in the table ‘Compliance’ 345. Clinical guidelines can consist of several steps that must be followed in order and or with a specific temporal relationship. To accommodate this the primary key for this table is a composite index of the fields ‘ClinGuidelineID’ and ‘SeqNo. The field ‘ClinGuidelineID’ may be a unique long integer. The field ‘SeqNo’ is a number field with the value ‘1’ for the first clinical guideline step. Subsequent guideline steps have an incremental value for the field ‘SeqNo’. Each step of a clinical guideline can have a temporal value associated with it which is stored in the fields ‘TimeWhen’ which is a long integer field, and ‘TimeUnits’ which is a text field of length 8. For instance if a medication is to be taken 3 times per day then the value of ‘TimeWhen’ would be coded as the ‘3’ and the value of ‘TimeUnits’ would be coded as ‘times per day’. The field ‘GuidelineText’ is a text field of length 255 with the text of the step of the clinical guideline. The fields ‘DiagnosisMaj’ and ‘DiagnosisMin’ of table ‘ClinGuidelines’ 340 have a many-to-one primary-foreign key relationship with the fields ‘DiagnosisMaj’ and ‘DiagnosisMin’ of table ‘Diagnoses’ 335 and have the same attributes.

Table ‘ClinGuidelines’ has a Boolean field ‘Recommended’. This is set to ‘true’ if the clinical guideline is the recommended treatment guideline. This is the guideline that the exemplary system will use when prompting medical personnel to enter treatment instructions. If the medical practitioner changes the recommended guideline by editing, adding or deleting or fully changing the recommended steps, and the new treatment instructions are inserted into the ‘ClinGuidelines’ table 340, with unique value for ‘ClinGuidelineID’, and ‘SeqNo’, and a value of ‘false’ for the field ‘Recommended. In this manner, the table ‘ClinGuidelines’ 340 can have entries for a single ‘Recommended’ treatment guideline for a diagnosis, and can also contain multiple customized treatment guidelines for that same diagnosis.

Treatment guidelines change frequently to reflect new research and medications, and it is difficult for the health care practitioner to maintain a comprehensive up-to-date knowledge of the latest treatment guidelines. Often more specificity may be added to treatment guidelines to distinguish the treatment preference for patients depending on age, sex, and ethnicity. Since the treatment guidelines in the exemplary system may be accessed over a network, the medical practitioner will always be prompted with the most up-to-date treatment guidelines from the source site.

Table ‘Compliance’ 345 contains standard compliance information about every diagnosis for the compliance categories ‘alerts’, ‘followup’, ‘diagnosis information’ and ‘treatment information’. These are fixed by the exemplary system and in a preferred embodiment may not be edited by the health care practitioner. The primary key ‘ComplianceID’ may be a unique long integer. The field ‘ComplianceType’ is a text field of length 8 and identifies the type of compliance information contained in the record. It may take the values ‘alerts’, ‘followup’, ‘daiginfo’, or ‘trtmnt’ for ‘alerts’, ‘followup’, ‘diagnosis information’ and ‘treatment information’ respectively. The field ‘ComplianceText’ is a text field of length 255 and contains compliance specific descriptive information for the record. The field ‘ComplianceURL’ is a text field of length 255 and contains the URL of compliance specific descriptive information for the record. The fields ‘DiagnosisMaj’ and ‘DiagnosisMin’ of table ‘Compliance’ 345 have the same definition and attributes as the fields ‘DiagnosisMaj’ and ‘DiagnosisMin’ of table ‘Diagnoses’ 335.

In this exemplary system, ‘alerts’ and ‘followup’ are presented in separate sections to highlight their importance, to the patient. Alerts are items of information of special importance, such as possible medication side effects or symptoms that the patient should be aware that if they occur, immediate medical attention is required. Followup refers to future follow-up medical examination.

In the exemplary system, the disease specific treatment and diagnosis resource information that will be made available to the patient is a URL or Internet resource. The exemplary system allows this information to be presented to the user according to the language preference of the patient. Table ‘Patients’ 305 contains a field ‘PrefMedLang’ which records the patients preferred language. When the patient uses the exemplary system to hyperlink to the disease or treatment information, the link is to an address that is modified by the language preference so the information is presented to the patient according to their preference. As an example, if the patient language preference has a value of ‘Spanish’ then when the patient hyperlinks to ‘Diabetes/Mellitus’ treatment information at the URL given in the Compliance table, the exemplary system will hyperlink to URL/Spanish so as to get the Spanish language version of the associated treatment information.

Table ‘PatCompliance’ 350 contains information about the treatment instructions that have been issued to a patient and the status of their compliance. The primary key ‘PatComplIdx’ may be a unique long integer. The field ‘DiagnosisID’ of table ‘PatCompliance’ 350 has a many-to-one primary-foreign key relationship with the field ‘DiagnosisID’ of table ‘Diagnosis’ 330 and has the same attributes. The field ‘EncounterID’ of table ‘PatCompliance’ 350 has a many-to-one primary-foreign key relationship with the field ‘EncounterID’ of table ‘MedEncounter’ 320 and has the same attributes. The field ‘PatComplType’ is a text field of length 8 and has a value representing the type of compliance information. It may take the values ‘alerts’, ‘followup’, ‘diaginfo’, ‘trtmnt’, or ‘inst’. If it has one of the values ‘alerts’, ‘followup’, ‘diaginfo’, or ‘trtmnt’ then the field ‘PatComplianceID’ of table ‘PatCompliance’ 350 has a many-to-one primary-foreign key relationship with the field ‘ComplianceID’ of table ‘Compliance’ 345. If the field ‘PatComplType’ has the value ‘inst’ then the field ‘PatComplianceID’ of table ‘PatCompliance’ 350 has a many-to-one primary-foreign key relationship with the field ‘ClinGuidelineID’ of table ‘ClinGuidelines’ 340. The field ‘dateAccessed’ is a date field that contains a date and time stamp for when the patient accessed the treatment instructions and will be used by the exemplary system to calculate the patients measure of compliance. The field ‘TrackIt’ is a Boolean field. The default value is ‘false’ but can be set by the Medical Personnel to the value ‘true’. If the value is ‘false’ then the exemplary system will not automatically generate reminder messages to the patient about the associated compliance item, if the patient is non-compliant. If the value is set to ‘true’ then the exemplary system will automatically generate reminder message if the patient is non-compliant

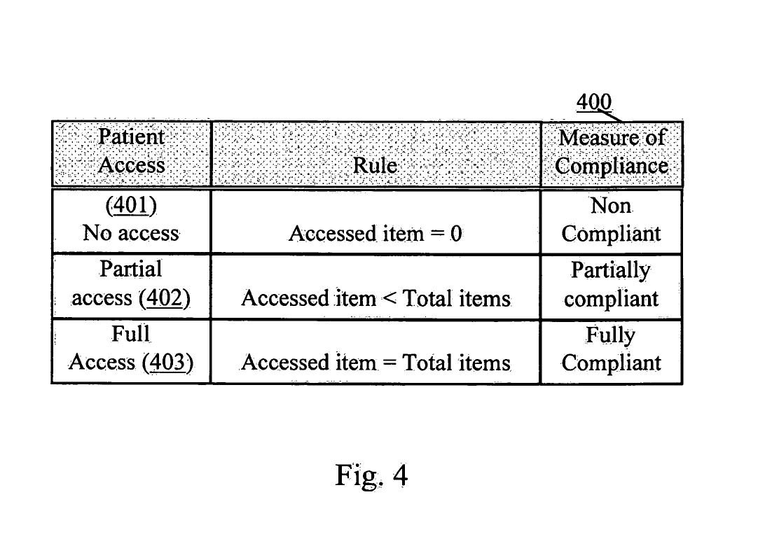

FIG. 4 displays the definition of the patient's measure of compliance. In a preferred embodiment, every patient can be assigned a ‘Measure of Compliance’ 400 for any specific medical visit, or for any combination of 2 or more medical visits. For the one or more visits that are to be measured we count the ‘Total items’ that the patient is to access and the ‘Visited items’ that the patient has accessed. In a preferred embodiment compliance is only measured for medical visits more than one week old. These numbers can be calculated directly from the ‘PatEncounter’ table 360 of FIG. 3. First get the set of entries for the field ‘EncounterID’ 361 for the set of patient medical visits more than one week old that are to be measured. Since each medical visit is uniquely identified by the field EncounterID 361, the ‘Total items’ is defined as the number of records in the PatCompliance table 360 with an EncounterID in this set and a ‘DateEncounter’ more than one week old. The ‘Visited items’ is defined as the number of records in the PatCompliance table 360 with an EncounterID in this set and a non-null entry for the dateAccessed field 362 of the table PatCompliance 360. These two numbers are then compared. If the ‘Total items’ is equal to the ‘Visited items’ then the ‘Measure of compliance’ 400 for the patient's visits is ‘Fully Compliant’. If the ‘Visited items’ is zero and the ‘Total items is greater than zero then the ‘Measure of Compliance’ 400 for the patient's visits is ‘Non-compliant’. If the ‘Visited items’ is less than the ‘Total items’ then the ‘Measure of Compliance’ 400 for the patient's visits is ‘Partially compliant’. Other embodiments may use other means to measure a patient's compliance with medical care instructions.

In this section we will describe the user interface for the exemplary system, and will display the main screens that the patient and medical personnel users of the exemplary system encounter.

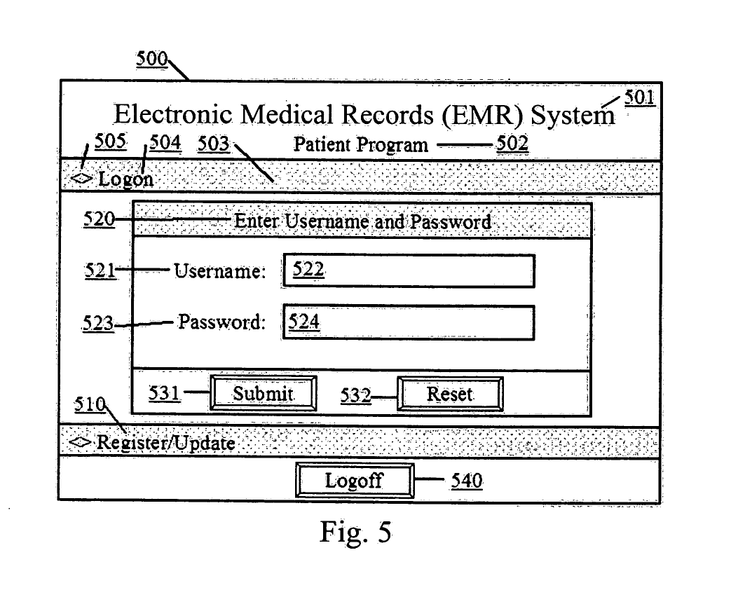

FIG. 5 is an example 500 of the first screen presented to the patient on the display screen 201 that the patient encounters when they start the exemplary patient program. One exemplary purpose of the exemplary patient program is to allow the patient to review online their treatment instructions. A second exemplary purpose is to make a record of the information that is accessed by the patient so the automatic compliance reminder feature of the exemplary system can be invoked.

This is the logon screen and the patient is not allowed to view their treatment instructions until they logon with an authorized Username and Password. It shows the title banner 501 for the exemplary system, ‘Electronic Medical Records (EMR) System’ which will be displayed on all screens, and the specific program module, ‘Exemplary patient program’ 502. Other program modules are the Medical Personnel data entry and administration modules.

A solid shaded bar 503 across the screen delineates sections of the module. Each section is labeled, and in this instance is labeled ‘Logon’ 504. There is another section header on the logon screen 500 labeled ‘Register/Update’ 510, which the patient uses to register an authorized Username/Password so they may access the exemplary system or to update their registration information. On the solid shaded bar is the symbol ‘< >’ 505. System-wide, this is an indicator for expanding/contracting sections. In this exemplary case it means that by pointing and clicking the mouse any place on the solid shaded bar 503, the section will toggle to either expand or contract. In this figure the ‘Logon’ section 503 is shown expanded; i.e. all the fields of the section are displayed, and the ‘Register/Update’ section 510 is shown contracted with none of the fields of the section displayed.

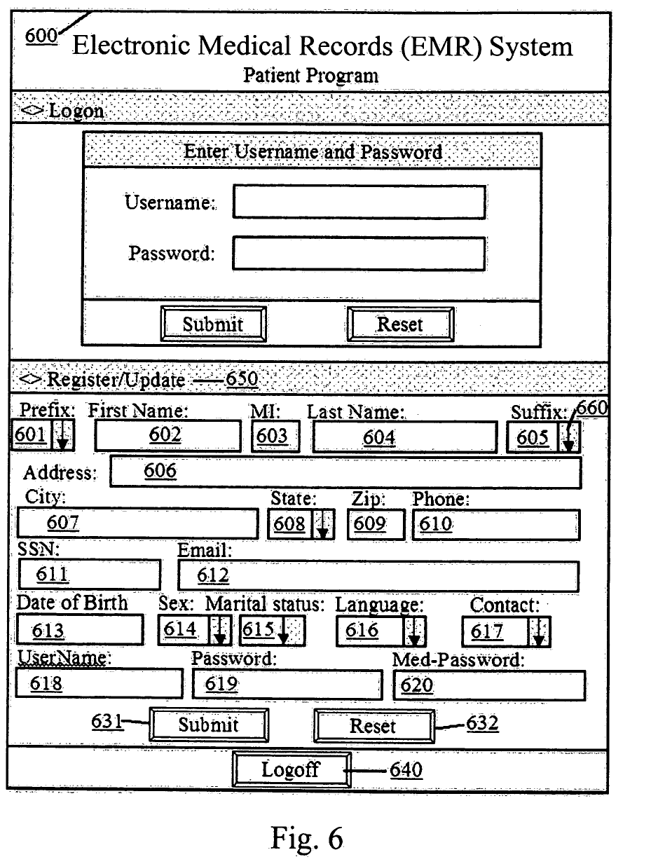

Throughout the modules of the exemplary system similar functionality is employed and will reoccur in FIGS. 6 through 15. Whenever the symbol appears on a shaded bar it indicates that the information displayed in the section appearing immediately below it can be toggled to either fully display the data fields, or for the information displayed in the section to be hidden or contracted.

The information display items of the ‘Logon’ section 503 appear directly below the section bar. A display banner ‘Enter Username and Password’ 520 identifies the function of the screen which is to allow the user to type in the Username and Password and submit for authorization to review the patient's own treatment instructions. The label field ‘Username’ 521 identifies the data entry field 522 in which the patient enters their ‘Username’ and the label field ‘Password’ 523 identifies the data entry field 524 in which the patient enters their ‘Password’. The Username and Password entries are validated against the ‘Usemame’ and ‘Password’ fields stored in the patient's record in the table ‘Patients’ 305 in the fields ‘Username’ and ‘Password’.

The ‘Logon’ section has two buttons, ‘Submit’ 531 and ‘Reset’ 532. The ‘Submit’ button 531 causes the program to submit the entries in the data entry fields 522 and 524 to the treatment server program for patient authentication as the proper ‘Username’ and ‘Password’ respectively, waits for and displays the reply. The ‘reset’ button 532 causes the program to clear any key entries in the data entry fields 522 and 524 and set them back to their initial state.

In this example screen 500, the section 510 ‘Register/Update’ is shown contracted so the data entry fields are not displayed. An example of this section in expanded view, caused by pointing and clicking anywhere in the shaded bar 510, will be shown in FIG. 6.

At the bottom of the ‘Logon’ screen is the button ‘Logoff’ 540. This button is selected by the user by pointing and clicking the mouse-pointing device at the button and causes the program to back to an initial state prior to any logon. If the patient has successfully logged in, and then selected the ‘Logoff’ button, they will not be allowed to review their treatment instructions until the again ‘Logon’ to the exemplary patient program. This ‘Logoff’ button 540 will be repeated on every screen of the Patient Module.

FIG. 6 is an example 600 of the first screen presented to the patient on the display screen 201 that the patient encounters when they start the exemplary patient program but with both ‘Logon’ section 504 and the ‘Register/Update’ section expanded to show all data entry fields. The patient would navigate from the display in FIG. 5 to the display in FIG. 6 by using the mouse pointer to point and click at the shaded bar 510 that is labeled ‘Register/Update’. The program then redisplays the exemplary patient program screen as shown in FIG. 6. From FIG. 6 the user could return to the display as it appears in FIG. 5 by using the mouse pointer to point and click at the shaded bar 650 which will cause the program to collapse the ‘Register/Update’ section and hide the data entry fields. The ‘Register/Update’ data entry section may have two exemplary purposes for the exemplary patient program. If it is invoked before the patient logs on then it is used to register the patient as a new user. This same section will be available to the patient after they have successfully logged onto the exemplary system. In that case, their current registration information is filled into the data entry fields of the ‘Register/Update section and they can update their registration information by changing the information in a field and selecting the ‘Submit’ button 631 which causes the program to send the information to the treatment information server to be used to update the treatment information database, wait for and display the reply.

The data entry fields in the ‘Register/Update’ section include all of the fields in the Patient Table 305 except PatientID, DateEntered, DateUpdated, and MeasCompliance, which in this exemplary system are managed by the database program. The data entry fields labeled Prefix 601, First Name 602, MI 603, Last Name 604, Suffix 605, Address 606, City 607, State 608, Zip 609, Phone 610, SSN 611, Email 612, Date of Birth 613, Sex 614 Marital Status 615, Language 616, Contact 617, Username 618, Password 619, and Med-Password 620, correspond respectively to the data fields, Prefix FName, MI, LName, Suffix, Address, City, State, Zip, Ph, SSN, Email, DOB, Sex, MaritalStatus, PrefMedLang, PrefMeansContact Username, Password, and PIN of the table Patients 305. When the user selects the ‘Submit’ button 631, the information is preferably sent to the treatment information server for posting into the treatment information database, waits for and displays the reply.

Two of the fields, Language 616 and Contact 617 allow the patient to enter their preferences as an exemplary means of customizing how the exemplary system interacts with them. The choice of language 617 indicates that language by which the patient prefers to view treatment instructions, and the preferred means of contact 617 indicates the means by which the user prefers to receive reminder compliance notification.

In the exemplary system, every patient has 2 Passwords. The Password field ‘Password’ 619 is used by the patient to access their treatment instructions from the exemplary patient program. In order for medical personnel to access a patients records and enter treatment instructions from the exemplary medical personnel data entry program, they have to have authorization from the patient in the form of the patients ‘Username’ 618 and ‘Med-Password’ 620 also called a ‘PIN’. The ‘Username’ and ‘Med-Password’ field 620 or PIN allows selective access to the patient's information in the treatment instructions database from the exemplary medical personnel program but not the exemplary patient program. The ‘Username’ and ‘Password’ field 619 allows access to the patient's information in the treatment instructions database from the exemplary patient program but not from the exemplary medical personnel data entry program. The use of two Passwords provides a means by which the level of access and update control to patient's information can be provided for patients and medical personnel. The user may use the ‘Register/Update’ section 650 at any time to change the ‘Username’ 618, ‘Password’ 619, or ‘Med-Password’ 620.

Exemplary fields are shown with a down pointing arrow 605 on the right hand side of the data entry field. This indicates that the field is a drop-down box, and that the program already displays the only valid entries. The entries are accessed by using the mouse pointer to point and click at the arrow box 660 and a list of possible entries for the patient to select with the mouse pointer will be displayed. For example, the allowable entries in the drop-down box field ‘Prefix’ 601 are ‘Mr.’, ‘Mrs’, ‘Dr.’, and ‘Ms.’. The allowable entries in the drop-down box field ‘Suffix’ 605 are ‘Ph.D.’, ‘DVM’, ‘Sr’, and ‘Jr’. The allowable entries in the drop-down box field ‘State’ 608 are all the 2-character standard abbreviations for the 50 states of the United States. The allowable entries in the drop-down box field ‘Sex’ 614 are ‘M’ and ‘F’ for male and female respectively. The allowable entries in the drop-down box field ‘Marital Status’ 615 are ‘Married’, ‘Single’, ‘Divorced’ and ‘Widowed’. The allowable entries in the drop-down box field ‘Language’ 616 are ‘English’ and ‘Spanish’. The allowable entries in the drop-down box field ‘Contact’ 617 are ‘Email’, ‘Phone’, ‘Beeper’, and ‘Regular mail’.

The buttons ‘Submit’ 631, ‘Reset’ 632 and ‘Logoff’ 640 have the same functionality to that shown in the similarly named buttons ‘Submit’ 531, ‘Reset’ 532 and ‘Logoff’ 540 of FIG. 5.

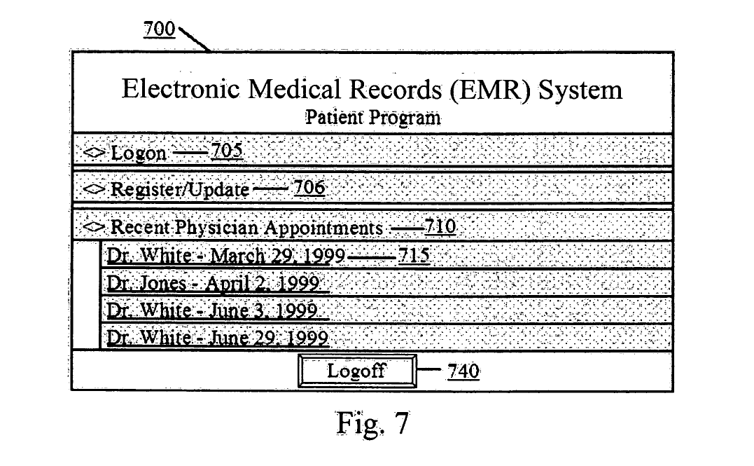

FIG. 7 is an example 700 of the list of the patient's medical appointments on the display screen 201 that are in the treatment information database and can be reviewed by the patient. In order to navigate to this screen, the user would have had to successfully log into the exemplary system with their Username and Password.

The display shows three shaded section bars, ‘Logon’ 705, ‘Register/Updates’ 706, and ‘Recent Physician Appointments’ 710. Using the mouse pointer to point and click at any of these shaded bars will cause the program to collapse the display of the section if it is expanded, or to expand the display of the section if it is collapsed. In this example, the ‘Logon’ and ‘Register/Updates’ sections are collapsed hiding their respective data entry fields and the ‘Recent Physician Appointments’ section 710 is in expanded mode.

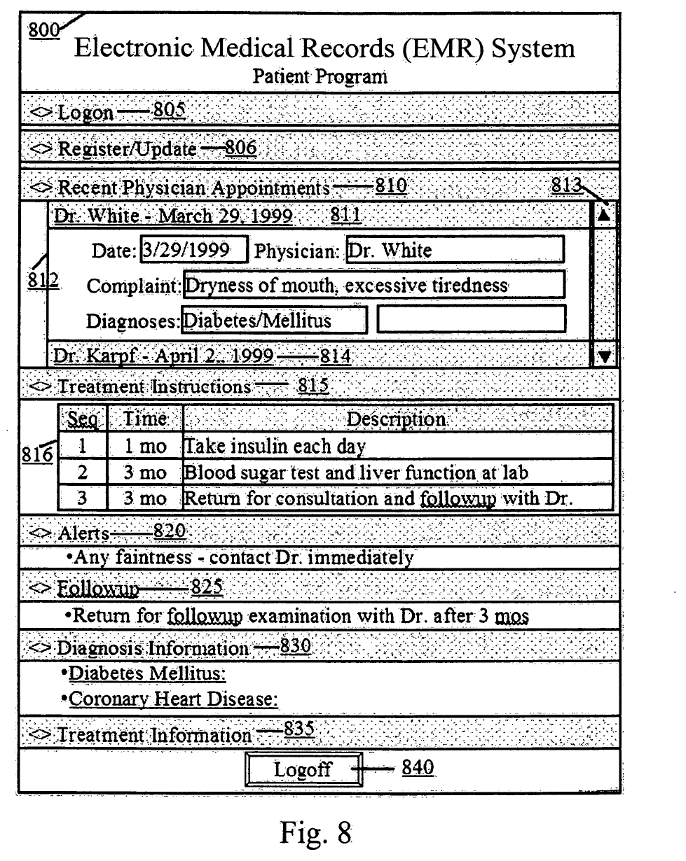

The ‘Recent Physicians Appointments’ section 710 shows four recent appointments for the patient. The first appointment 715 shows an appointment with Dr. White on Mar. 29, 1999. Note that the appointment is underlined. The user can view the compliance information for that appointment by using the mouse pointer to point and click at the underlined appointment listing. This will cause the program to send a message to the treatment information server to retrieve the compliance information and redisplay the screen as in FIG. 8, with the specific compliance information from that appointment.

The button ‘Logoff’ 740 has the same functionality to that shown in the similarly named ‘Logoff’ 540 of FIG. 5.

FIG. 8 is an example 800 of the Exemplary patient program screen on the display screen 201 that the patient encounters when they have selected a recent medical appointment to view. The display shows eight shaded section bars, ‘Logon’ 805, ‘Register/Update’ 806, and ‘Recent Physician Appointments’ 810, ‘Treatment Instructions’ 815, ‘Alert’ 820, ‘Followup’ 825, ‘Diagnosis Information’ 830, and ‘Treatment Information’ 835. Using the mouse pointer to point and click at any of these shaded bars will cause the program to collapse the display of the section if it is expanded, or to expand the display of the section if it is collapsed. In this example, the ‘Logon’, ‘Register/Update’, and ‘Treatment Information’ sections are collapsed hiding their respective data fields and the ‘Recent Physician Appointments’, ‘Treatment Instructions’, ‘Alerts’, ‘FollowUp’ and ‘Diagnosis Information’ sections are in expanded mode.

The section ‘Recent Physician Appointments’ 810 shows the data fields for the recent appointment 811 with Dr. White on Mar. 29, 1999. This section 812 shows appointment data fields that include the date, physician name, patient's complaint and the diagnosis. There is a scroll bar 813 that the patient may use to scroll through other appointments headers. The patient may select another appointment to view by using the mouse pointer to point and click at a session identifier 814 which will cause the exemplary patient program to send a request to the server to retrieve the information session information, wait for and display the reply.

The treatment instructions are displayed in the section ‘Treatment Instructions’ 815. The treatment information 816 for the selected appointment is displayed in a grid ordered according to the sequence and time order in which the instructions are to be followed. The alerts are displayed in the section ‘Alerts’ 820, and are a list of one or more alerts that the patient should be especially aware of. Alerts may be symptoms that should they occur the patient should seek immediate medical attention. The followup information is displayed in the section ‘FollowUp’ 825 and is a list of the medical followup, if any, that the user should schedule to continue medical treatment associated with their complaint. The resource information related to the diagnosis is displayed in the section ‘Diagnosis Information’ 830, and in this exemplary case is a list of links to web sites that have relevant diagnosis information. The patient can use the mouse pointer to point and click at the links and retrieve the information pages for review. The resource information related to the treatment is displayed in the section ‘Treatment Information’ 835. Similarly to the Diagnosis information, in this exemplary case, this section has links (not shown) to web sites that have relevant treatment information. The diagnosis and treatment information will be presented to the user according to their language preference.

In the example of FIG. 8, the patient has accessed the instructions and information about their appointment on Mar. 29, 1999. For patient compliance purposes, the exemplary system records that the patient has accessed the treatment information for the March 29 appointment. The exemplary system will not record that the patient has accessed the treatment information for the other appointments until the patient specifically selects that appointment from the ‘Recent Physician Appointment’ sections 810 and brings the information up on the screen of the exemplary patient program.

The button ‘Logoff’ 840 has the same functionality to that shown in the similarly named ‘Logoff’ 540 of FIG. 5.

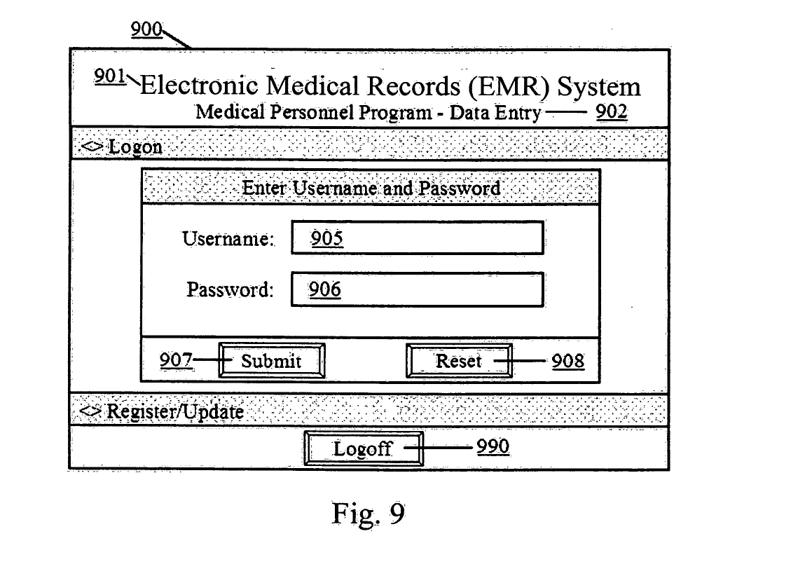

FIG. 9 is an example 900 of the first screen presented to medical personnel on the display screen 201 that medical personnel encounter when they start the exemplary medical personnel data entry program. An exemplary purpose of the exemplary medical personnel data entry program is for authorized medical personnel to enter the treatment instructions that are issued after a medical examination.

This is the logon screen and medical personnel are not allowed to invoke the patient data entry functions until they logon with an authorized Username and Password. The screen layout is entirely similar in layout and functionality to that of the exemplary patient program logon screen 500. For instance it shows the title banner 901 for the exemplary system, ‘Electronic Medical Records (EMR) System’ which is the same as the title banner 501 for the exemplary patient program. The only difference in appearance is the name of the specific program module, ‘Medical Personnel Program—Data Entry’ 902.

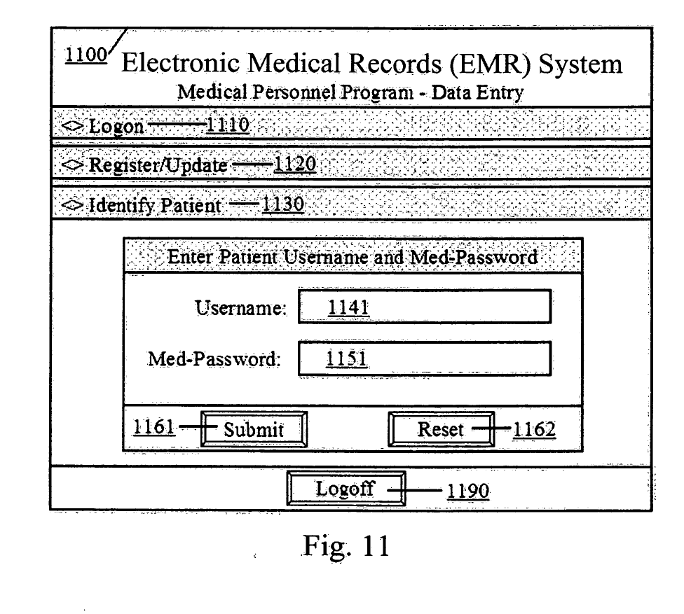

In the exemplary system, functionally this data entry screen is similar to that of the exemplary patient program logon screen 500. The solid shaded bars work as in all screens—when selected by pointing and clicking the mouse anyplace on the solid bar, the section will toggle to either expand and display the data fields or contract to hide the data fields. The data entry fields ‘Username’ 905 and ‘Password’ 906 are the fields that the medical personnel use to enter their logon information to the exemplary system. After entering this information, selecting the ‘Submit’ button 907 sends the Username and Password to be validated against valid entries in the MedPersonnel table 310, and the program waits and displays the response. If the logon is validated the program redisplays the screen as shown in FIG. 11, and if it is not validated then this same logon screen is redisplayed. The ‘Reset’ button 908 causes the program to clear any entries from the fields labeled ‘Username’ 905 and ‘Password’ 906. The Logoff button 990 causes the program to terminate the Medical Personnel data entry session. If Medical Personnel had logged onto the exemplary system which provided them with access to patients records, then the Logoff function will deny them access until they again successfully logon.

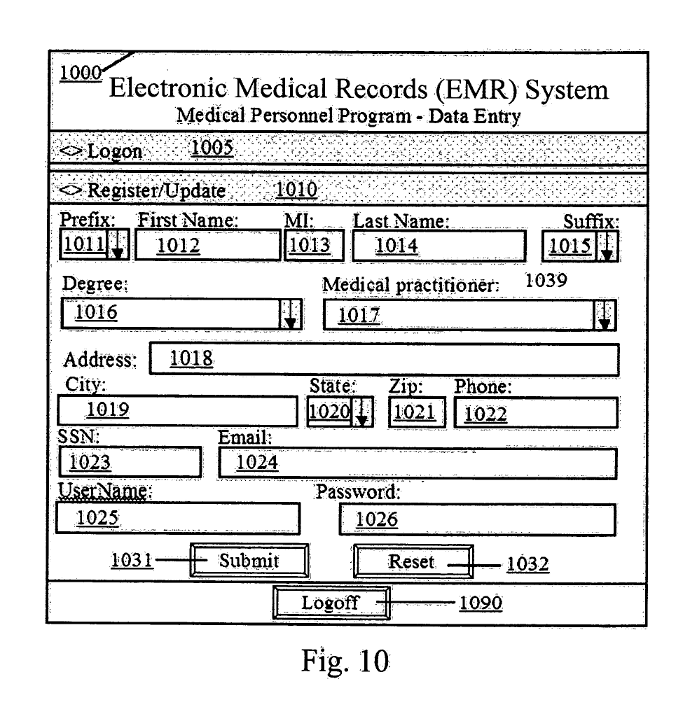

FIG. 10 is an example 1000 of the first screen presented to the medical personnel on the display screen 201 encountered when they start the exemplary medical personnel data entry program. It shows the exemplary medical personnel data entry program of FIG. 9 but with the ‘Logon’ section 1005 contracted to hide the data fields and the ‘Register/Update’ section 1010 expanded to show the fields used for medical personnel to register to use the exemplary system or to update their logon information. The ‘Register/Update’ section has two exemplary purposes for the exemplary medical personnel program. If it is invoked before the medical personnel logs on then it is used to register the medical personnel as a new user. This same section will be available to medical personnel after they have successfully logged onto the exemplary system. In that case, their current registration information is filled into the data entry fields of the ‘Register/Update’ section and they can update their registration information by changing the information in a field and selecting the ‘Submit’ button 1031 which causes the program to send the information to the treatment instruction sever to be used to update the exemplary treatment instruction database, wait and display the reply.

The data entry fields in the ‘Register/Update’ section include all of the fields in the ‘MedPersonnel’ table 310 except MedPersID, DateEntered, and DateUpdated that are preferably managed by the database program. The data entry fields labeled Prefix 1011, First Name 1012, MI 1013, Last Name 1014, Suffix 1015, Degree 1016, Medical Practitioner 1017, Address 1018, City 1019, State 1020, Zip 1021, Phone 1022, SSN 1023, Email 1024, Username 1025, and Password 1026, correspond respectively to the data fields, Prefix, Fname, MI, Lname, Suffix, Degree, MedPersType, Address, City, State, Zip, Ph, SSN, Email, Username, and Password of the table ‘MedPersonnel’ 310. When the user selects the ‘Submit’ button 1090, the information is preferably sent to the treatment information server for posting into the treatment information database, and the program waits and displays the response. Several of the fields have a down pointing arrow on the right hand side of the data entry field. This indicates, as in the exemplary patient program, that the field is a drop-down box, and that the only valid entries are those displayed by the program. The buttons ‘Submit’ 1031, ‘Reset’ 1032 and ‘Logoff’ 1090 have similar functionality to that shown in the similarly named buttons ‘Submit’ 907, ‘Reset’ 908 and ‘Logoff’ 990 of FIG. 9.

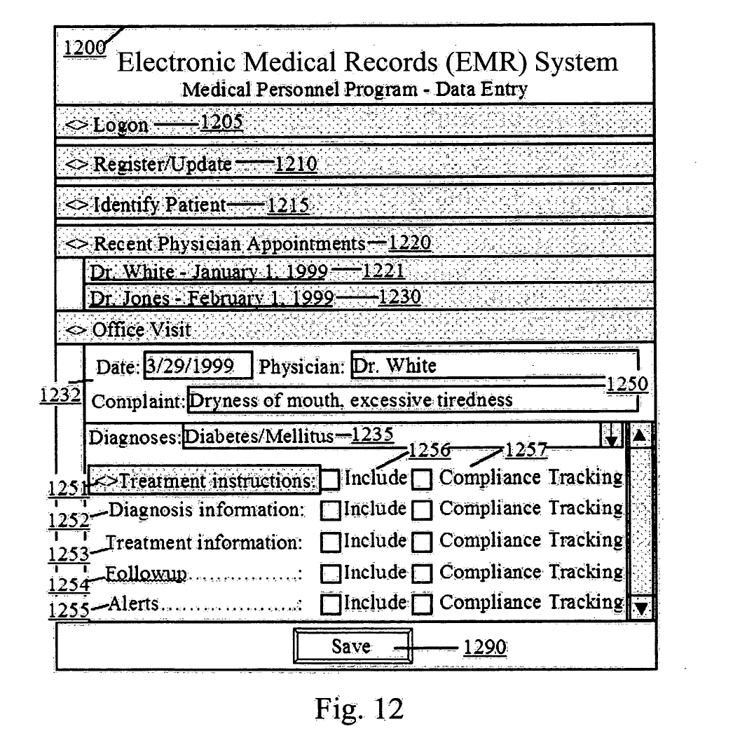

FIG. 11 is an example 1100 of the first screen on the display screen 201 presented to the Medical personnel after they have successfully logged onto the exemplary system. An exemplary purpose of this screen is to allow the medical personnel to identify the patient for whom they will data enter medical examination compliance information. The display shows three shaded section bars, ‘Logon’ 1110, ‘Register/Update’ 1120, and ‘Identify Patient’ 1130. Using the mouse pointer to point and click at any of these shaded bars will cause the program to collapse the display of the section if it is expanded, or to expand the display of the section if it is collapsed. In this example, the ‘Logon’ and ‘Register/Update’ sections are collapsed hiding their respective data entry fields and the section ‘Identify Patient’ 1130 is in expanded mode. The medical personnel would enter the Username and Med-Password or PIN of the patient into the fields labeled ‘Username’ 1141 and ‘Med-Password’ 1151. The Med-Password is the Password that is setup by the patient to give selective access to a patient's EMR, for example, the patient providing it to the Medical personnel to allow medical personnel to perform data entry and administration of their office visit compliance information. The authorized medical personnel would then select the ‘Submit’ button 1161 which would send the values in the fields labeled ‘Username’ 1141 and ‘Med-Password’ 1151 for authorization and wait and display the results. If the authorization is successful then the screen of FIG. 12 is displayed, but if it is not successful then this screen of FIG. 11 is redisplayed. If the medical personnel select the reset button then the entries in the fields labeled ‘Username’ 1141 and ‘Med-Password’ 1151 would be cleared of their entries. The Logoff button 1190 has the same functionality as the similarly named button 990.

FIG. 12 is an example 1200 of the screen on the display screen 201 used by the medical personnel to enter the compliance information for a patient's office visit in accordance with a preferred embodiment of the invention. An exemplary purpose of this screen is for the medical personnel to enter the treatment instruction information for the patient's office visit. The display shows five major sections ‘Logon’ 1205, ‘Register/Update’ 1210, ‘Identify Patient’ 1215, ‘Recent Physician Appointments’ 1220, and ‘Office Visit’ 1230. The first three sections have the same functionality as in FIGS. 10 and 11. Note that by selecting the ‘Identify Patient’ 1215 section, the medical personnel will be presented with the ‘Enter Username and Med-Password’ logon screen of FIG. 11, and can enter the Username and Med-Password to work with a different patient. They can therefore work with a different patient without having to go through the Medical Personnel Login again. The section ‘Recent Physician Appointments’ 1220 lists prior appointments that have already been recorded in the exemplary system. In this example two prior appointments are shown and both are underlined, which indicates that by using the mouse pointer to point and click at the appointment, will bring up a screen that displays the specifics of that appointment.

The section ‘Office Visit’ 1230 is the section in which the treatment instructions are entered. First there is a section 1232 with the date of appointment to be entered, and the Physician, and the complaint. Below that there is a drop-down box field in which the diagnosis is entered. For each diagnosis selected the medical personnel specifies whether to include ‘Treatment instructions’ 1251, ‘Diagnosis Information’ 1252, ‘Treatment Information’ 1253, ‘FollowUp’ 1254, or ‘Alerts’ 1255. For each of these types of information the medical personnel can put an ‘x’ in the checkbox ‘Include’ 1256 to include the associated treatment instruction. If the checkbox is left blank then the associated information is not included in the treatment instructions. The medical personnel also use a checkbox ‘Compliance Tracking’ 1257 in a similar fashion to indicate to the exemplary system whether the treatment instructions included for the patient should be tracked automatically by the exemplary system and compliance reminders sent if the patient is non-compliant. This button can only be selected if the associated treatment instruction has been ‘included’ 1256.

The treatment instructions can be viewed in the ‘Treatment instructions’ section 1251. When the user points and clicks at this section the recommended treatment guidelines are displayed in a popup dialog window with the sequence of treatment guidelines displayed in a text grid. Medical personnel can edit these instructions. Any modification to the treatment guidelines results in the information being inserted into the ClinGuidelines table 340 with a unique ClinGuidelineID and SeqNo.

On this screen the Save button 1290 causes the Exemplary medical personnel data entry program to send the office visit information, diagnosis, and treatment instruction information to the treatment instruction server and redisplay the screen as in FIG. 11.

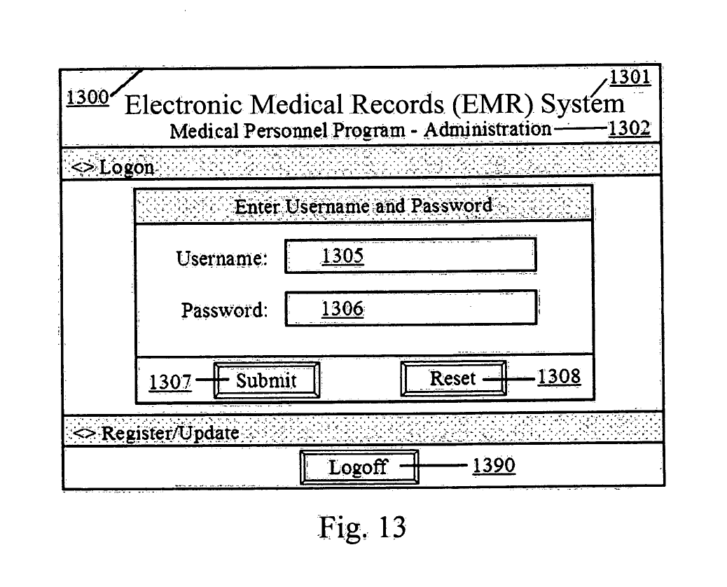

FIG. 13 is an example 1300 of the first screen presented to medical personnel on the display screen 201 that medical personnel encounter when they start the exemplary medical personnel administration program. An exemplary purpose of the exemplary medical personnel administration program is to allow authorized medical personnel to review the compliance of patients with their prescribed medical instructions.

In this exemplary system, this is the logon screen and medical personnel are not allowed to invoke the administration functions until they logon with an authorized Username and Password. The screen layout is entirely similar in layout and functionality to that of the exemplary patient program logon screen 500 and to that of the exemplary medical personnel data entry program 900. For instance we show the title banner 1301 for the exemplary system, ‘Electronic Medical Records (EMR) System’ which is the same as the title banner 501 for the exemplary patient program and as the title banner 901 for the exemplary medical personnel data entry program. The only difference in appearance is the name of the specific program module, ‘Medical Personnel Program—Administration’ 1302.

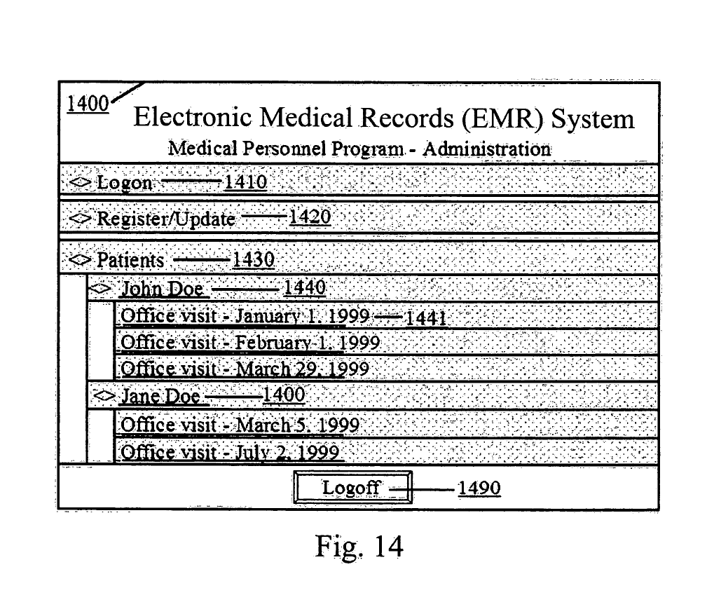

Functionally this data entry screen is similar to that of the medical personnel data entry 900. The solid shaded bars work as in all screens—when selected by pointing and clicking the mouse anyplace on the solid bar the section will toggle to either expand and display the fields or contract to hide the fields. The data entry fields ‘Username’ 1305 and ‘Password’ 1306 are the fields that the medical personnel use to enter their logon information to the exemplary system. After entering this information, selecting the ‘Submit’ button 1307 sends the values in the fields labeled ‘Username’ 1305 and ‘Password’ 1306 to be validated against valid entries in the ‘MedPersonnel’ table 310, and the program waits and displays the results. If the logon is validated the program redisplays the screen as shown in FIG. 14. If the logon is not validated then the screen of FIG. 13 is redisplayed. If the medical personnel select the ‘Reset’ button 1308 by using the mouse pointing device to point and click at button, then the data entry fields ‘Username’ 1305 and ‘Password’ 1306 are cleared of any entries. The ‘Logoff’ button 13990 causes the program to terminate the Medical Personnel administration session. If Medical Personnel had logged onto the exemplary system which provided them with access to patients records, then the ‘Logoff’ function will deny them access until they again successfully logon.

FIG. 14 is an example 1400 of the screen presented to the medical personnel on the display screen 201 when they have first successfully logged into the exemplary system. The display shows five shaded section bars. The sections ‘Logon’ 1410 and ‘Register/Update’ 1420 are the same as described in FIGS. 12 and 13. There is a new section ‘Patients’ 1430 which lists all patients that the Medical Personnel may review. This section has its own sections—one for every patient listed. In this example there are just two patients John Doe and Jane Doe. The office visits for John Doe are listed in the section ‘John Doe’ 1440 and the office visits for Jane Doe are listed in the section ‘Jane Doe’ 1450. The data fields for the patient specific sections are the list of office visits for that patient. Each entry 1441 in the list is underlined which indicates that by using the mouse device to point and click at the office visit entry, compliance information for that office visit will be displayed. The ‘Logoff’ button 1490 has the same functionality as the similarly named button 1390.

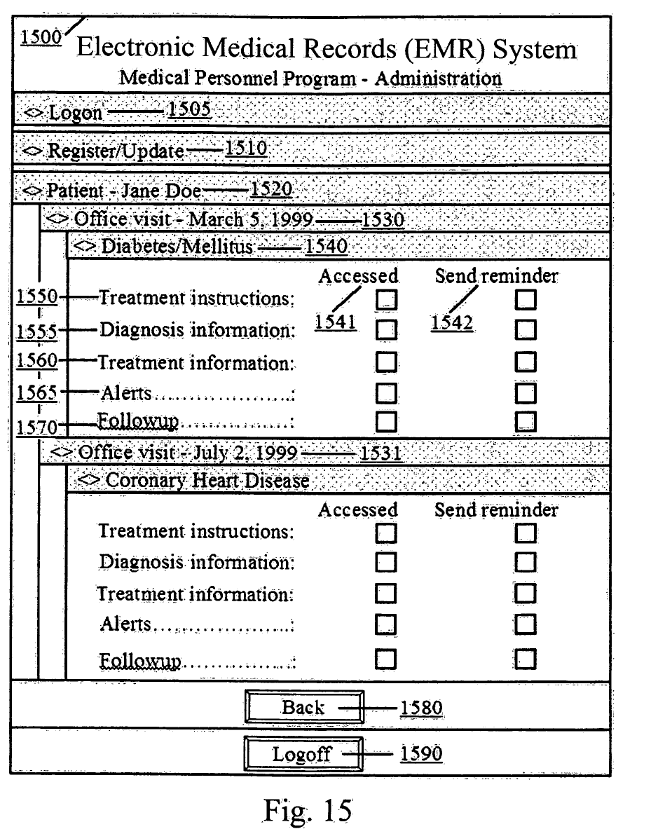

FIG. 15 is an example 1500 of the compliance status screen presented to the medical personnel on the display screen 201 when they have selected a patient for review. In this exemplary case the medical personnel has selected to review the compliance information for the patient Jane Doe. The display shows seven shaded section bars. The sections ‘Logon’ 1505 and ‘Register/Update’ 1510 are the same as described in FIGS. 13 and 14. There is a new section ‘Patients’—Jane Doe’ 1520 under which the compliance information for the patient Jane Doe will be displayed. Each office visit (1530,1531) is presented as its own section in descending chronological order. Within each office visit, there is a section displaying the compliance information for each diagnosis 1540. If there are multiple diagnoses at an office visit then each diagnoses is displayed in its own section. In this exemplary system, the compliance information that is presented is for five categories of compliance information—‘Treatment instructions’ 1550, ‘Diagnosis Information’ 1555, ‘Treatment Information’ 1560, ‘Alerts’ 1565 and ‘FollowUp’ 1570. In this exemplary system, for each category the information about whether the patient has accessed the information is contained in a checkbox ‘Accessed’ 1541. If the checkbox has an ‘x’ in it then the patient has accessed the corresponding type of information. If the checkbox is empty then the patient has not accessed the corresponding type of information. The medical personnel uses the checkbox ‘Send reminder’ 1542 to explicitly request the exemplary system to send a reminder compliance message to the patient. If the medical personnel places an ‘x’ in the checkbox, by using the mouse pointing device to point and click at the checkbox, then a reminder compliance message will be sent by the treatment server program to the patient. The ‘Back’ button 1580 will cause the program to redisplay the prior screen with a list of the visits for all patients as shown in FIG. 14. The ‘Logoff’ button 1590 has the same functionality as the similarly named button 1390.

In the exemplary system, the ‘Measure of Compliance’ 400 provides a reasonable surrogate measure for actual compliance, and is used by the exemplary system to track a patients access to the treatment information resources. All patients that are not fully up-to-date in reviewing the treatment information are automatically sent reminders.

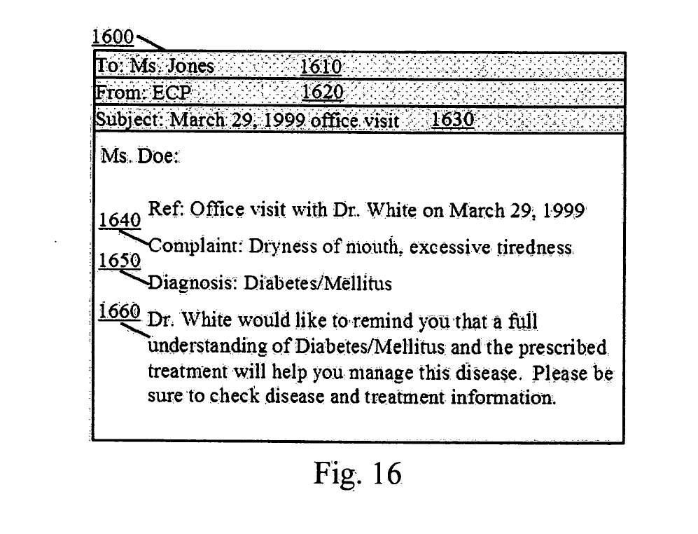

FIG. 16 is an example 1600 of an Email reminder that is sent automatically by the treatment information database program to a patient who is not fully compliant with the post-examination treatment instructions as measured by the ‘Measure of Compliance’ 400. It is a standard Email message addressed to the patient in the ‘To’ Email address 1610, sent by the Electronic Medical Records (EMR) System identified in the ‘From’ Email address 1620, and with a subject line 1630 indicating to the patient that this is a reminder about the Mar. 29, 1999 office visit. The body of the E-mail further references the patient's medical examination by listing the complaint 1640 at the time of the office visit and the diagnosis 1650. A short message 1660 reminds the patient to check information relevant to the referenced office visit.

A preferred embodiment uses an industry standard Ethernet and an industry standard TCP/IP network protocol for its computer network. A computer network conversation between the exemplary patient program and the exemplary treatment database program is implemented by establishing a connection between the computers over the computer network. Similarly, a computer network conversation between the exemplary medical personnel program and the exemplary treatment database program is implemented by establishing a connection between the computers over the computer network. Similarly, a computer network conversation between the exemplary medical personnel administration program and the exemplary treatment database program is implemented by establishing a connection between the computers over the computer network.

Preferably, to minimize the computer resources utilized to maintain these connections, this exemplary system uses a non-persistent network connection; i.e. a network connection is established between the client and server computers only for the length of time necessary to perform a specific transaction.

In a preferred embodiment the connections are implemented using the industry standard hypertext transport protocol (http). In other embodiments the non-persistent connection may be implemented using another industry standard protocol, or a special non-persistent protocol may be implemented specifically to address the operation of this system. If any of the client programs (exemplary patient program, medical personnel program or medical personnel administration program) or the exemplary treatment database program terminates their connection with the other program, either by design or another reason, such as a network outage, the other program also terminates its connection state.

The operation of a preferred embodiment of the client programs all rely heavily on sections of information that are toggled to expand and contract when the user points and click with the mouse pointer device at the section header. For instance FIG. 5 show a ‘Register/Update’ section 510 in collapsed mode. In FIG. 6 this same ‘Register/Update section 650 is shown in expanded mode. Throughout the specification of the client programs, expanding and collapsing of sections is implemented using specific features of the HTML 4.0/CSS 1.0 standards. Expanding a section displays the information for the user and collapsing has the opposite effect.

Similarly, after the client program is first displayed there will be one or more ‘Submit’ buttons displayed. Selecting a ‘Submit’ button by pointing and clicking with the mouse pointer device will cause the Web browser to access and display on the display screen a new page associated with a URL. This is implemented in all client programs by use of the html FORMS tags with the value of the action attribute set to the URL of the client program and name-value pairs of the QueryString set by the web browser when the user select a ‘Submit’ button. This too is standard html programming understood and well known to those skilled in the art. The ‘Reset’ button is also used throughout the client programs, always in tandem with the ‘Submit’ button. The ‘Reset’ button resets all fields contained within the FORMS tag to their initial values, and is standard html programming understood and well known to those skilled in the art.

Finally, throughout the client programs we use hyperlinks. This is indicated by underlined test. By pointing and clicking with the mouse pointer device at a hyperlink, will cause the web browser to display the URL referenced by the hyperlink. Hyperlinking is central to the notion of web programming, is standard html programming understood and well known to those skilled in the art. In some instances the hyperlink information will be displayed in a new window that ‘floats’ on top of the client program. This too is a general facility of web programming that is well known to those skilled in the art.

Similarly with other functionality of the client programs, the means by which the functionality is implemented are standard html/css coding and are well known to those skilled in the art. The specification will therefore focus on the logic of the exemplary systems and the algorithms employed to implement the exemplary systems. For each of the three client programs, Patient, Medical Personnel data entry, and Medical Personnel administration programs, we provide the description by means of the standard systems design tools—state diagrams and state tables.

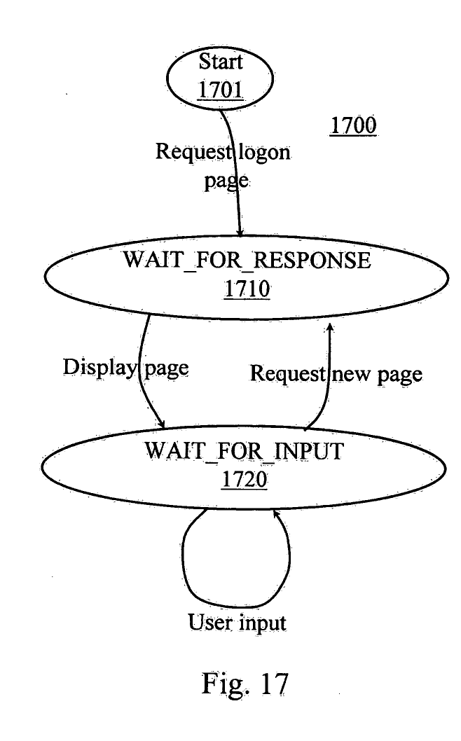

FIG. 17 is a state diagram 1700 showing the state machine describing the logical operation of the exemplary patient program. The state diagram shows the different states that the program may occur in, and the actions that cause them to change to another state.

In the exemplary system, after starting the Exemplary patient program the exemplary patient program is either waiting for a response from the server program or waiting for input from the user. State ‘START’ 1701 represents the program state when the Web Browser is started and a request is sent via http to the server program for the patient logon page. After sending the request the program immediately transfers to the ‘WAIT_FOR_REPONSE’ 1710 state, awaiting the receipt via http of the html file that will display the requested logon page of the Exemplary patient program on the display screen of the Web Browser. When the html file is received it is displayed or rendered by the browser on the display screen and then processing transfers to the ‘WAIT_FOR_INPUT’ 1720 state in which the Exemplary patient program awaits user keyboard or computer mouse input.

In the exemplary system, there are two distinct type of actions that may occur in the ‘WAIT_FOR_INPUT’ 1720 state. The user may interact with the screen as when they use the mouse to point-and-click at a section to expand or contract it, or key enter information in one of the data entry fields displayed on the screen. This type of interaction between the user and the program results in changes to the currently displayed screen but does not cause a request to be sent to the server program for a new page. In this exemplary case the program processes the user input and remains in the state ‘WAIT_FOR_INPUT’ 1720.

The second type of action that may occur is when the user initiates an action, such as pressing the ‘Submit’ button 540 of FIG. 5, which causes a http request message to be sent to the server requesting a new page. In this exemplary case the message is sent and the program transfers to the state ‘WAIT_FOR_REPSONSE’, awaiting the reception of a new page. When that page is received, it is displayed on the display screen of the Web Browser and the program transfers to the state ‘WAIT_FOR_INPUT’ awaiting action from the user.

The state machine for the Exemplary patient program 1700 clearly shows the reliance on the browser and the server programs for the operation of this module of the exemplary system. The browser is the operational platform that displays html pages and interacts with the user. The user may initiate actions that will result in a message to the server to formulate a new html page, wait for the response from the server, and display a new page of the patient system according to the specifics of the message request.

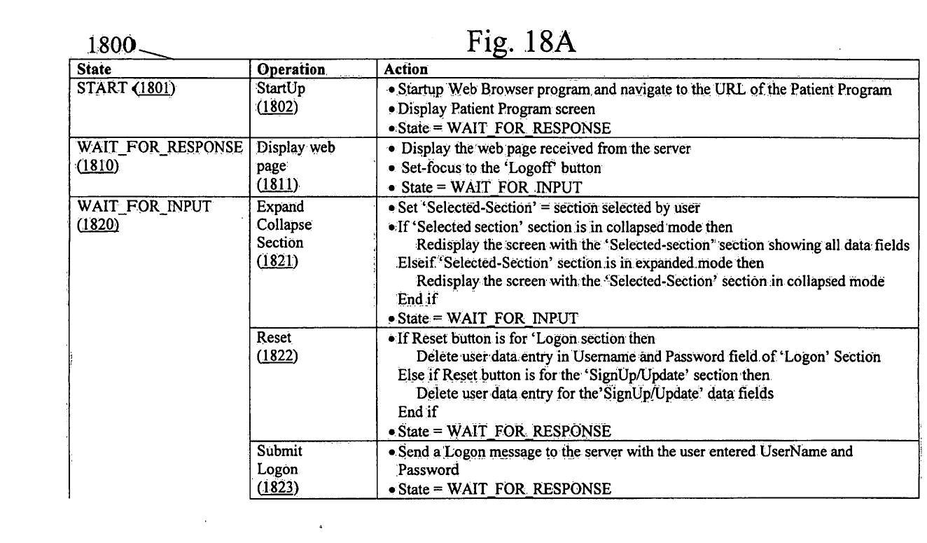

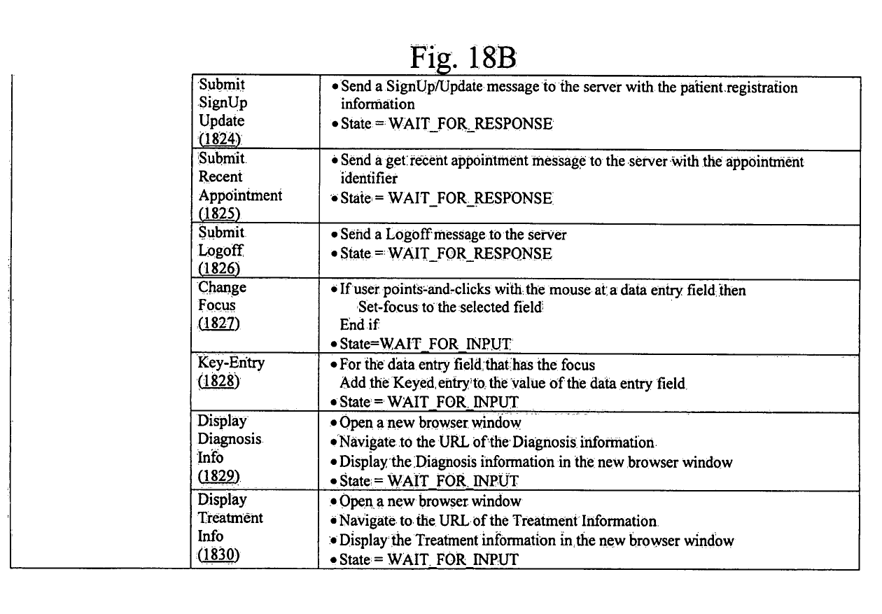

FIG. 18A and FIG. 18B is a state table 1800 for the operation of Exemplary patient program. In the exemplary system, it has 3 states, START 1801 which corresponds to the state 1701 of FIG. 17, WAIT_FOR_RESPONSE 1810 which corresponds to the state 1710 of FIG. 17, and WAIT_FOR_INPUT 1820 which corresponds to the state 1720 of FIG. 17. The state table provides more detail on the operation of the Exemplary patient program.

When the Exemplary patient program is started it immediately enters the logical state START 1801 in which the Internet Explorer Web Browser program is started in the ‘StartUp’ operation 1802. The Web Browser uses the Universal Resource Locator (URL) of the Exemplary patient program to request the html file with the logon screen for the Exemplary patient program. In this exemplary case the URL is only the name of the Network Resource with the Exemplary patient program ASP file and has no ‘QueryString’ associated with it. After requesting the file, the program transfers to the state WAIT_FOR_RESPONSE 1810 and when the file is received, performs the operation ‘Display web page’ 1811 and displays the Exemplary patient program logon screen, sets the focus to the ‘Logoff’ button 540 of FIG. 5, and transfers to the state ‘WAIT_FOR_INPUT’ 1820.

The state ‘WAIT_FOR_INPUT’ 1820 is the state in which the user interacts with the Exemplary patient program and so it is in this state that most of the html/css programming is done.

If the operation is to ‘Expand or Collapse’ a section 1821 then if the selected section is in collapsed mode then the screen is redisplayed with the selected section in expanded mode. If the selected section is in expanded mode then the screen is redisplayed in collapsed mode. In a preferred embodiment the sections are set to their respective modes by programming the DHTML ‘onclick’ event to set the style property display attribute of the sections html DIV tag to ‘NONE’ to collapse the section and ‘BLOCK’ to display it.

If the operation is to ‘Change focus’ 1827 then the browser resets the focus to the selected field. This will most often occur with the data entry fields. For instance if the user is entering a Username into the Username field 522 of FIG. 5, then the focus of the browser has to be on this data entry field so the browser will update the Username data entry field with the keyed values. The web browser changes the focus when the user points and clicks at a data entry field or uses the ‘Tab’ key to navigate to a new field. If the operation is ‘Key-Entry’ 1828, then the key entered is appended to the values in the data entry field that has the focus. This operation is handled by the web browser and includes support for ‘Backspace’ and ‘Del’ to remove previously keyed characters.

If the operation is to ‘Submit Logon’ 1823 then the Web Browser submits a request to the server program to validate the Username and Password of the user. The Web Browser uses the Universal Resource Locator (URL) of the Exemplary patient program with the ‘QueryString’ set to name-value pairs with the Username and Password. This URL request is sent to the server and the program enters the state ‘WAIT_FOR_REPONSE’ 1810 waiting to receive and display a new page of the Exemplary patient program. If the treatment database server program can validate the Username and Password then it will respond with a screen containing Patient Information including recent appointments. If the treatment database server program cannot validate the Username and Password then it will respond with the Exemplary patient program logon screen.

If the requested operation is to ‘Submit SignUp/Update’ 1824 then the Web Browser submits a request to the server program to either sign-up a new patient or to update the patient's information in the treatment instructions database. The Web Browser uses the URL of the Exemplary patient program with the QueryString set to the name-value pairs of the ‘Register/Update’ section 650 of FIG. 6. This URL request is sent to the server and the program enters the state ‘WAIT_FOR_RESPONSE’ 1810 waiting to receive and display a new page of the Exemplary patient program. If the SignUp is successful then the user will be able to further use the exemplary system. However at the time of registration there will be no medical appointments in the exemplary system so there will be no treatment instruction information to review. If the update is successful, then they will be logged into the exemplary system, if not already logged in, and the server will respond with the same screen as after a successful ‘Submit Logon’ 1823.

If the requested operation is ‘Submit Recent Appointment’ 1825, then the patient is requesting to review the treatment information for a selected appointment. The Web Browser uses the URL associated with the underlined (hyperlink) appointment 715 of FIG. 7 to request a new Exemplary patient program screen with the appointment information. The URL request is sent to the server and the program enters the state ‘WAIT_FOR_RESPONSE’ 1810 waiting to receive and display a new page, similar to FIG. 8, with the patient's treatment instruction information for the specified medical appointment.

For both the patient ‘Logon’ section and the ‘SignUp/Update’ section there is a ‘Reset’ button. If the selected operation is ‘Reset’ 1822, then the data entry fields associated with the respective sections are cleared to their initial state with no entries.

If the requested operation is ‘Display Diagnosis Info’ 1829, then the patient has selected a hyperlink to a website that contains diagnosis information. The Web browser opens a new browser window and displays the hyperlink URL with the diagnosis information. This will cause the exemplary system to hyperlink to the resource in the language preference of the patient by linking to a subdirectory of the URL with the language specific information. For instance if the value of the Patients language preference is ‘Spanish’ then the exemplary system may access information about Diabetes/Mellitus at the network site URL/Spanish/DiabetesMellitus.html. The window will ‘float’ on top of the Exemplary patient program window and will remain displayed until the Patient closes it. The Exemplary patient program remains fully operational even while the web browser manages the second diagnosis information window.

If the requested operation is ‘Display Treatment Info’ 1830, then the patient has selected a hyperlink to a website that contains treatment information. The Web browser opens a new browser window and displays the hyperlink URL with the treatment information. Analogously to disease information, treatment information is displayed in the language preference of the patient. The window will ‘float’ on top of the Exemplary patient program window and will remain displayed until the Patient closes it. The Patient remains full operational even while the web browser manages the second treatment information window.

If the requested operation is ‘Submit Logoff’ 1826, then the Web Browser submits a request to the server program to log the patient out of the exemplary system. The program uses the URL of the Exemplary patient program with the QueryString indicating ‘Logoff’. The URL request is sent to the server and the program enters the state ‘WAIT_FOR_RESPONSE’ 1810 waiting to receive and display a new ‘Logon’ pages just as if it had transitioned from the ‘Start’ state 1801.

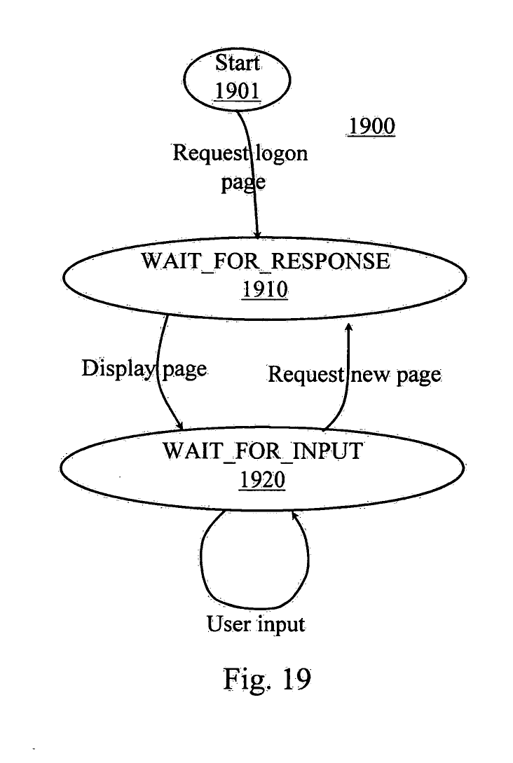

FIG. 19 is a state diagram 1900 showing the state machine describing the logical operation of the exemplary Exemplary medical personnel data entry program. After invocation the program is either waiting for a response from the server program or waiting for input from the user. State ‘START’ 1901 represents the program state when the Web Browser is started and a request is sent via http to the server program for the Medical Personnel logon page. After sending the request the program immediately transfers to the ‘WAIT_FOR_REPONSE’ 1910 state, awaiting the receipt via http of the html file that will display the requested logon page of the Exemplary medical personnel data entry program on the display screen of the Web Browser. When the html file is received it is displayed or rendered by the browser on the display screen and then processing transfers to the ‘WAIT_FOR_INPUT’ 1920 state in which the Exemplary medical personnel data entry program awaits user keyboard or computer mouse input.

There are two distinct type of actions that may occur in the ‘WAIT_FOR_INPUT’ 1920 state. The user may interact with the screen as when they use the mouse to point-and-click at a section to expand or contract it, or key enter information in one of the data entry fields displayed on the screen. This type of interaction between the user and the program results in changes to the presently displayed screen but does not cause a request to be sent to the browser for a new page. In this exemplary case the program processes the user input and remains in the state ‘WAIT_FOR_INPUT’ 1920.

The second type of action that may occur is when the user initiates an action, such as pressing the ‘Submit’ button 907 of FIG. 9, which causes a http request message to be sent to the server requesting a new page. In this exemplary case the message is sent and the program transfers to the state ‘WAIT_FOR_REPSONSE’ 1910, awaiting the reception of a new page. When that page is received, it is displayed on the display screen of the Web Browser and the program transfers to the state ‘WAIT_FOR_INPUT’ awaiting action from the user.

The state machine for the exemplary medical personnel program 1900 clearly shows the reliance on the Web Browser and the Web Server for the operation of this module of the exemplary system. In the exemplary system, the browser is the operational platform that displays html pages and interacts with the user. The user may initiate actions that will result in a message to the server to formulate a new html page, wait for the response from the server, and display a new page of the Medical Personnel Data Entry system according to the specifics of the message request.

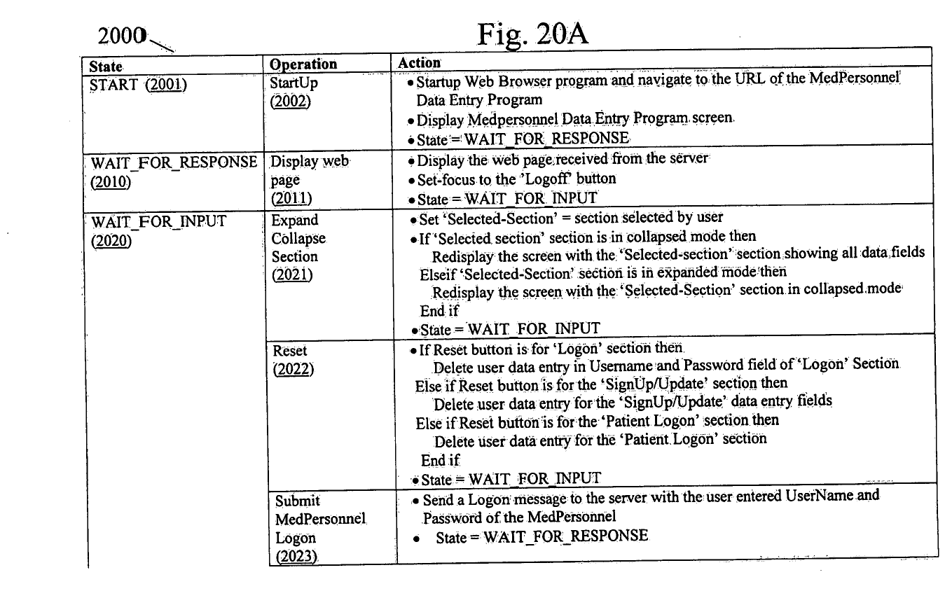

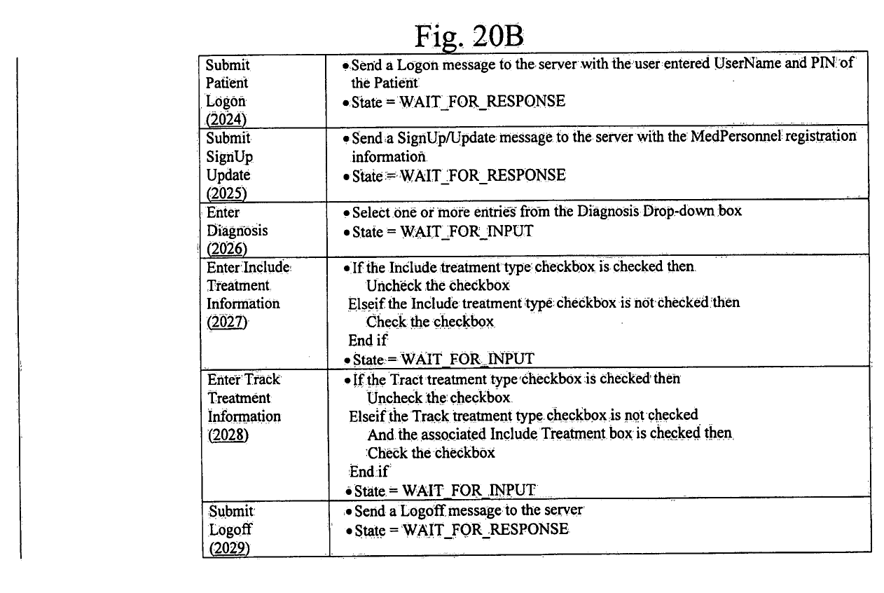

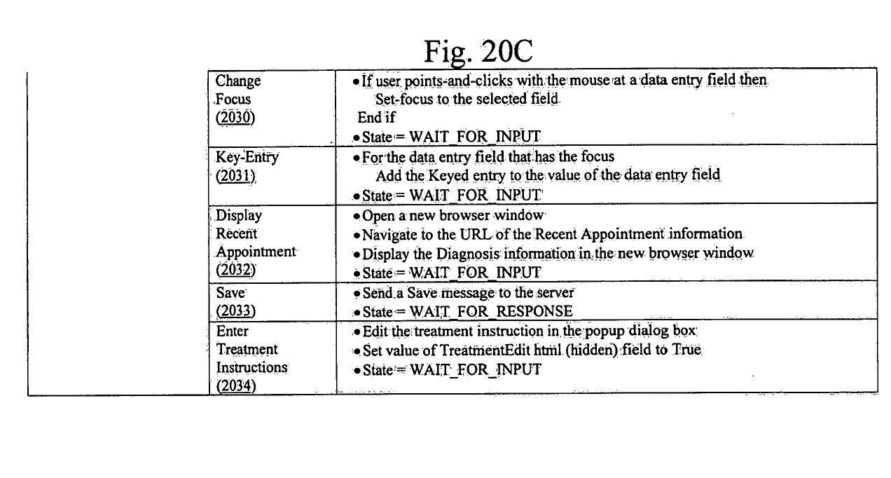

FIG. 20A, FIG. 20B, and FIG. 20C is a state table 2000 for the operation of Exemplary medical personnel data entry program. It has 3 states, START 2001 which corresponds to the state 1901 of FIG. 19, WAIT_FOR_RESPONSE 2010 which corresponds to the state 1910 of FIG. 19, and WAIT FOR INPUT 2020 which corresponds to the state 1920 of FIG. 19. The state table provides more detail on the operation of the Exemplary medical personnel data entry program.

When the Exemplary medical personnel data entry program is started it immediately enters the logical state START 2001 in which the Internet Explorer Web Browser program is started in the StartUp operation 2002. The Web Browser uses the Universal Resource Locator (URL) of the Exemplary medical personnel data entry program to request the html file with the logon screen. In this exemplary case the URL is the network resource of the Medical Personnel Data Entry ASP file and has no QueryString associated with it. After requesting the file, the program transfers to the state WAIT_FOR_RESPONSE 2010 and when the file is received, performs the operation ‘Display web page’ 2011 and displays the Exemplary medical personnel data entry program logon screen, sets the focus to the ‘Logoff’ button 990 of FIG. 9, and transfers to the state ‘WAIT_FOR_INPUT’ 2020.

The state ‘WAIT_FOR_INPUT’ 2020 is the state in which the user interacts with the Exemplary patient program and so it is in this state that most of the html/css programming is done. There are 14 different operations that the program must be capable of handling.

If the operation is to ‘Expand or Collapse’ a section 2021 then if the selected section is in collapsed mode then the screen is redisplayed with the selected section in expanded mode. If the selected section is in expanded mode then the screen is redisplayed in collapsed mode. In a preferred embodiment the sections are set to their respective modes by programming the DHTML ‘onclick’ event to set the style property display attribute of the sections html DIV tag to ‘NONE’ to collapse the section and ‘BLOCK’ to display it.

If the operation is to ‘Change focus’ 2030 then the browser resets the focus to the selected field. This will most often occur with the data entry fields. For instance if the user is entering a Username into the Username field 905 of FIG. 9, then the focus of the browser has to be on this data entry field so the browser will update the Username field. The web browser changes the focus when the user points and clicks at a data entry field-or uses the ‘Tab’ key to navigate to a new field. If the operation is ‘Key-Entry’ 20, then the key entered is appended to the values in the data entry field that has the focus. This operation is handled by the web browser and includes support for ‘Backspace’ and ‘Del’ to remove previously keyed characters.

If the operation is to ‘Submit MedPersonnel Logon’ 2023 then the Web Browser submits a request to the server program to validate the Username and Password of the Medical Personnel. The Web Browser uses the Universal Resource Locator (URL) of the Exemplary medical personnel data entry program with the QueryString set to name-value pairs with the Username and Password. This URL request is sent to the server and the program enters the state ‘WAIT_FOR_REPONSE’ 2010 waiting to receive and display a new page of the Exemplary medical personnel data entry program. If the treatment database server program can validate the Username and Password then it will respond with a screen requesting patient logon information. If the treatment database server program cannot validate the Username and Password then it will respond with the Exemplary medical personnel data entry program logon screen.

If the operation is to ‘Submit Patient Logon’ 2024 then the Web Browser submits a request to the server program to validate the Username and PIN of the Patient so the Medical Personnel may enter treatment instruction information associated with the current medical appointment. The Web Browser uses the Universal Resource Locator (URL) of the Exemplary medical personnel data entry program with the QueryString set to name-value pairs with the Username and PIN. This URL request is sent to the server and the program enters the state ‘WAIT_FOR_REPONSE’ 2010 waiting to receive and display a new page of the Exemplary medical personnel data entry program. If the treatment database server program can validate the Username and PIN then it will respond with a screen similar to FIG. 12 in which the medical personnel may enter the treatment instruction information associated with the medical appointment. If the treatment database server program cannot validate the Username and PIN then it will respond with a screen similar to FIG. 11, in which the medical personnel has been validated but still requesting patient validation.

If the requested operation is to ‘Submit SignUp/Update’ 2025 then the Web Browser submits a request to the server program to either sign-up a new medical personnel or to update the medical personnel's information in the treatment instructions database. The Web Browser use the URL of the Exemplary medical personnel data entry program with the QueryString set to the name-value pairs of the ‘Register/Update’ section 1010 of FIG. 10. This URL request is sent to the server and the program enters the state ‘WAIT_FOR_RESPONSE’ 2010 waiting to receive and display a new page of the Exemplary medical personnel data entry program. If the Signup or update is successful then they will be logged into the exemplary system, if not already logged in, and the server will respond with the same screen as after a successful ‘Submit MedPersonnel Logon’ 2023.

In the exemplary system, for both the Medical Personnel ‘Logon’ section, the exemplary medical personnel program ‘Enter Patient Username and Pin’ section, and the ‘SignUp/Update’ section there is a ‘Reset’ button. If the selected operation is ‘Reset’ 2022, then the data entry fields associated with the respective sections are cleared to their initial state with no entries.

If the requested operation is ‘Display Recent Appointment’ 2032, then in the exemplary system the Medical Personnel has selected to display the treatment information for a specific patient's appointment in a new web browser window. The Web browser opens a new browser window and displays the patient appointment. The window will ‘float’ on top of the Exemplary medical personnel data entry program window and will remain displayed until it is closed. The Exemplary medical personnel data entry program remains fully operational even while the web browser manages the new patient appointment information window.

If the requested operation is ‘Enter Diagnosis’ 2026, then in the exemplary system the Medical Personnel will use the mouse pointer device to open the drop-down diagnosis field 1235 of FIG. 12, and select a diagnosis for the patient. Scrolling down to other diagnoses and treatment instructions data entry fields enters additional diagnoses. These diagnoses will be entered into the exemplary treatment instruction database for the patient's medical visit when the medical personnel select the ‘Save’ button 1290.

If the user requested operation is ‘Enter Include Treatment Information’ 2027, then in the exemplary system the Medical Personnel has selected to toggle a checkbox 1256 of FIG. 12, indicating that the patient should be instructed to use the associated information. Only if the checkbox is checked will the instructions be entered into the database. The posting of the indicated information to the exemplary treatment instruction database for a patient's medical visit occurs when the medical personnel select the ‘Save’ button 1290.

If the requested operation is ‘Enter Track Treatment Information’ 2028, then in the exemplary system the Medical Personnel has selected to toggle a checkbox 1257 of FIG. 12, indicating that the exemplary system should track and automatically notify the patient about compliance to the associated treatment instructions. This checkbox can only be selected if the corresponding ‘Include’ checkbox 1256 has been checked. The posting of the indicated information to the exemplary treatment instruction database for a patient's medical visit occurs when the medical personnel select the ‘Save’ button 1290.

If the requested operation is ‘Submit Logoff’ 2029, then the Web Browser submits a request to the server program to log the Medical Personnel out of the exemplary system. The program uses the URL of the Exemplary medical personnel data entry program with the QueryString indicating ‘Logoff’. This has the effect of nullifying the Medical personnel logon to the exemplary system and displaying the screen as in FIG. 8.

If the requested operation is ‘Save’ 2033 then the medical personnel has entered the appointment specific information and is requesting that it be saved in the treatment instructions database. If treatment instruction information has been entered, then the values from the office visit section of FIG. 12 are included in the QuerySring name-value pairs that are sent to the server. The URL request is sent to the server and the program enters the state ‘WAIT_FOR_RESPONSE’ 2010 waiting to receive and display a patient login page as in FIG. 11.

If the requested operation is ‘Enter Treatment Instructions’ 2034 then the medical personnel has chosen to modify the recommend treatment guidelines for the associated diagnosis. The section ‘1251’ will redisplay as a popup dialog box with the recommended treatment guidelines in an editable text grid. The medical personnel can edit, delete and change the treatment instructions and close the popup dialog box. Making any change has the effect of changing the value of the html TreatmentEdit field to ‘true’. The default value is ‘false’. This html field is hidden from the user but its value is sent to the server along with other name-value pairs when the ‘Save’ button 1290 is invoked. The server will use this value as the means to either use the recommended and default value for the treatment guidelines (value=false) or to insert the edited values into the ClinGuidelines table 340 (value=true).

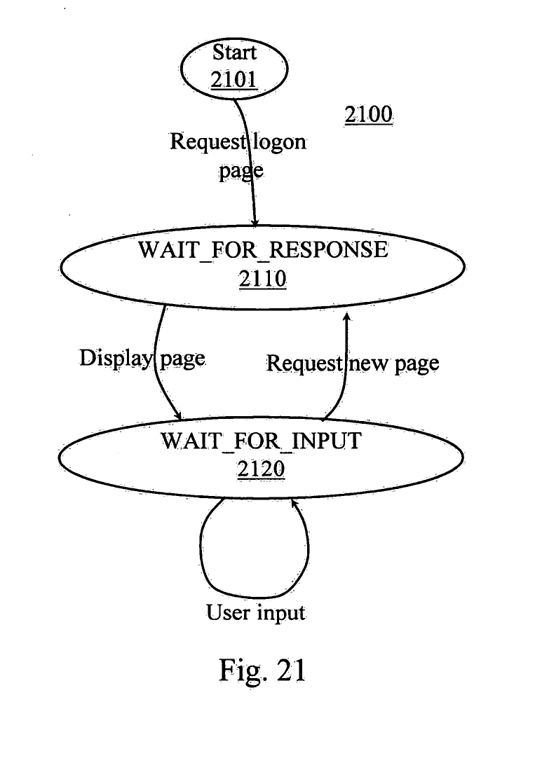

FIG. 21 is a state diagram 2100 showing the state machine describing the logical operation of the exemplary medical personnel administration program. After invocation the program is either waiting for a response from the server program or waiting for input from the user. State ‘START’ 2101 represents the program state when the Web Browser is started and a request is sent via http to the server program for the Medical Personnel logon page. After sending the request the program immediately transfers to the ‘WAIT_FOR_REPONSE’ 2110 state, awaiting the receipt via http of the logon html file that will display the requested page of the exemplary medical personnel administration program on the display screen of the Web Browser. When the logon file is received it is displayed or rendered by the browser on the display screen and then processing transfers to the ‘WAIT_FOR_INPUT’ 2120 state in which the exemplary medical personnel administration program awaits user keyboard or computer mouse input.

There are two distinct types of actions that may occur in the ‘WAIT_FOR_INPUT’ 2120 state. The user may interact with the screen as when they use the mouse to point-and-click at a section to expand or contract it, or key enter information in one of the data entry fields displayed on the screen. This type of interaction between the user and the program results in changes to the presently displayed screen but does not cause a request to be sent to the browser for a new page. In this exemplary case the program processes the user input and remains in the state ‘WAIT_FOR_INPUT’ 2120.

The second type of action that may occur is when the user initiates an action, such as pressing the ‘Submit’ button 1307 of FIG. 13, which causes a http request message to be sent to the server requesting a new page. In this exemplary case the message is sent and the program transfers to the state ‘WAIT_FOR_RESPONSE’, awaiting the reception of a new page. When that page is received, it is displayed on the display screen of the Web Browser and the program transfers to the state ‘WAIT_FOR_INPUT’ awaiting action from the user.

The state machine for the exemplary medical personnel administration program 2100 clearly shows the reliance on the Web Browser and the Web Server for the operation of this module of the exemplary system. The browser is the operational platform that displays html pages and interacts with the user. The user may initiate actions that will result in a message to the server to formulate a new html page, wait for the response from the server, and display a new page of the Medical Personnel Administration system according to the specifics of the message request.

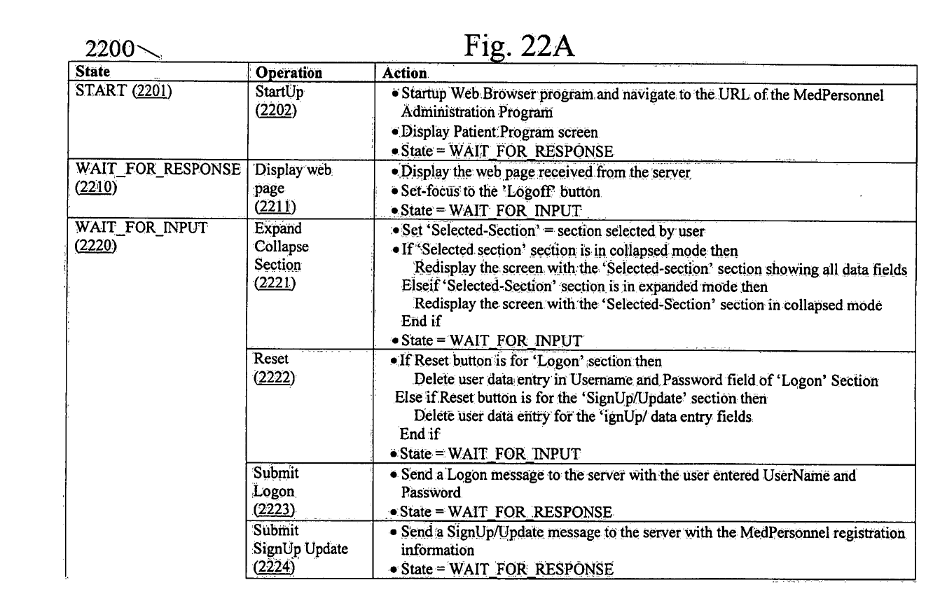

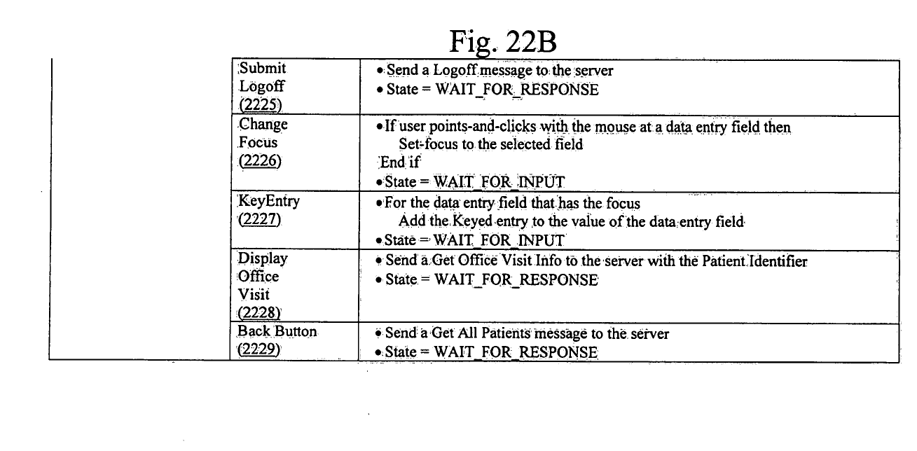

FIG. 22A and FIG. 22B is a state table 2200 for the operation of Medical Personnel Administration Program. It has 3 states, START 2201 which corresponds to the state 2101 of FIG. 21, WAIT_FOR_RESPONSE 2210 which corresponds to the state 2110 of FIG. 21, and WAIT_FOR_INPUT 2020 which corresponds to the state 2120 of FIG. 21. The state table provides more detail on the operation of the exemplary medical personnel administration program.

When the exemplary medical personnel administration program is started it immediately enters the logical state START 2201 in which the Internet Explorer Web Browser program is started in the StartUp operation 2202. The Web Browser uses the Universal Resource Locator (URL) of the exemplary medical personnel administration program to request the file with the logon screen. In this exemplary case the URL is the network resource of the Medical Personnel Data Entry ASP file and has no QueryString associated with it. After requesting the file, the program transfers to the state WAIT_FOR_RESPONSE 2210 and when the file is received, performs the operation ‘Display web page’ 2211, displays the exemplary medical personnel administration program logon screen, sets the focus to the ‘Logoff’ button 1390 of FIG. 13, and transfers to the state ‘WAIT_FOR_INPUT’ 2220.

The state ‘WAIT_FOR_INPUT’ 2220 is the state in which the user interacts with the Exemplary patient program and so it is in this state that most of the html/css programming is done. There are 9 different operations that the program must be capable of handling.

If the operation is to ‘Expand or Collapse’ a section 2221 then if the selected section is in collapsed mode then the screen is redisplayed with the selected section in expanded mode. If the selected section is in expanded mode then the screen is redisplayed in collapsed mode. In a preferred embodiment the sections are set to their respective modes by programming the DHTML onclick event to set the style property display attribute of the sections html DIV tag to ‘NONE’ to collapse the section and ‘BLOCK’ to display it.

If the operation is to ‘Change focus’ 2226 then the browser resets the focus to the selected field. This will most often occur with the data entry fields. For instance if the user is entering a Username into the ‘Username’ field 1305 of FIG. 13, then the focus of the browser has to be on this data entry field so the browser will update the ‘Username’ data entry field with the keyed values. If the operation is ‘Key-Entry’ 2227, then the key entry is appended to the values in the data entry field that has the focus. This operation is handled by the web browser and includes support for ‘Backspace’ and ‘Del’ to remove keyed characters.

If the operation is to ‘Submit Logon’ 2223 then the Web Browser submits a request to the server program to validate the Username and Password of the user. The Web Browser uses the Universal Resource Locator (URL) of the exemplary medical personnel administration program with the QueryString set to name-value pairs with the Username and Password. This URL request is sent to the server and the program enters the state ‘WAIT_FOR_REPONSE’ 2210 waiting to receive and display a new page of the exemplary medical personnel administration program. If the treatment database server program can validate the Username and Password then it will respond with a screen containing a list of all Patients seen by the Medical Personnel and all medical appointments by each patient. If the treatment database server program cannot validate the Username and Password then it will respond with the Exemplary patient program logon screen.

If the requested operation is to ‘Submit SignUp/Update’ 2224 then the Web Browser submits a request to the server program to either sign-up a new medical personnel or to update the medical personnel's information in the treatment instructions database. The Web Browser uses the URL of the exemplary medical personnel administration program with the QueryString set to the name-value pairs of the ‘Register/Update’ section 1010 of FIG. 10. This URL request is sent to the server and the program enters the state ‘WAIT_FOR_RESPONSE’ 2210 waiting to receive and display a new page of the exemplary medical personnel administration program. If the SignUp or update is successful then they will be logged into the exemplary system, if not already logged in, and the server will respond with the same screen as after a successful ‘Submit Logon’ 2223.

For both the Medical Personnel ‘Logon’ section and the ‘SignUp/Update’ section there is a ‘Reset’ button. If the selected operation is ‘Reset’ 2222, then the data entry fields associated with the respective sections are cleared to their initial state with no entries.

If the requested operation is to ‘Display Office Visit’ 2228 then the Web Browser submits a request to the server program to display the status of the treatment information for all appointments by the selected patient. The Web Browser uses the URL of the exemplary medical personnel administration program with the QueryString set to a name-value pair containing the patient's unique PatientID. The URL is sent to the server and the program enters the state ‘WAIT_FOR_RESPONSE’ 2210 waiting to receive and display a page similar to of FIG. 15.

The screen button ‘Back’ 1580 of FIG. 15 is displayed if the exemplary medical personnel administration program is displaying the treatment instruction information for a selected patient. If the selected operation is ‘Back Button’ 2229, then the Web Browser uses the Universal Resource Locator (URL) of the exemplary medical personnel administration program with the QueryString set to a name-value pair with the value ‘back’. This URL request is sent to the server and the program enters the state ‘WAIT_FOR_REPONSE’ 2210 waiting to receive and display a new page of the exemplary medical personnel administration program. The program responds with the ‘prior screen’; i.e. a screen containing a list of all Patients seen by the Medical Personnel and all medical appointments by each patient.

If the requested operation is ‘Submit Logoff’ 2225, then the Web Browser submits a request to the server program to log the Medical Personnel out of the exemplary system. The program uses the URL of the exemplary medical personnel administration program with the QueryString indicating ‘Logoff’. The URL request is sent to the server and the program enters the state ‘WAIT_FOR_RESPONSE’ 2210 waiting to receive and display a new ‘Logon’ pages just as if it had transitioned from the ‘Start’ state 2201. This nullifies the medical personnel login and results in the redisplay of the logon screen FIG. 13.

Among other things, the web server handles session management for a multiplicity of simultaneous client programs, memory management, object management, receipt and parsing of http message requests, dispatch of files to the client in response to an http request, and processing of Active Server Pages. The writing of server side Active Server pages to dynamically generate html files based on input from the user and information contained within a database is well known to those skilled in the art. The specification will therefore focus on the logic and algorithms employed to implement the server system.

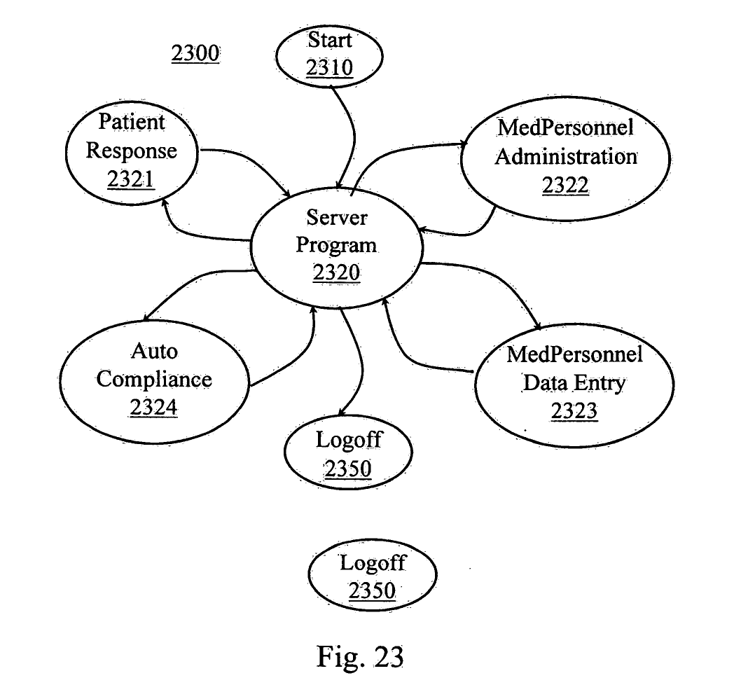

FIG. 23 is a state diagram 2300 for the operation of the treatment database server program. It shows the logical operation of the treatment instructions database server. At server startup ‘Start’ 2310 the program attempts to open the treatment instructions database. If it cannot be opened then it sends a message to the operator and immediately ends execution by transferring to the ‘End’ state 2380. The server program cannot run if the central treatment instructions database is not available. If the database is available then the server application program is started and the program transfers to the ‘Wait for Request’ state 2320, and waits for service requests from the client or to examine patients compliance and send reminders to non-compliant patients.

Logically, there are three different types of client service requests that the server program may receive, one each from the three different client programs in the exemplary system. While service requests from different clients may be handled very similarly, for clarity in the specification, the requests are categorized by the client program that forwarded the service request to the server. If the service request is from the exemplary patient program then the server processes the request in the ‘Patient Response’ state 2330. If the service request is from the Exemplary medical personnel data entry program then the server processes the request in the ‘MedPersonnel Data Entry’ state 2340. If the service request is from the exemplary medical personnel administration program then the server processes the request in the ‘MedPersonnel Administration’ state 2350. In each case when a service request message is received, the program transfers to the appropriate state, parses the message, processes the response and constructs the appropriate html response file, and passes the file back to the web server to send on to the client.

In the exemplary system, periodically, the treatment server program initiates execution of a compliance calculation and reminders program. An exemplary purpose of this program is to calculate compliance for each patient and for each patient session, store the calculated compliance in the database and send reminder messages to non-compliant patients. In the exemplary system, compliance is calculated according to the definition rule of FIG. 4, in which a patient is only compliant if they have used the Exemplary patient program to check all the treatment instructions specified by their medical practitioner, but limited to the set of medical appointments more than 1 weeks old and to treatment instructions that have the TrackIT boolean field of table PatCompliance 350 set to ‘true’. In a preferred embodiment, the treatment server program initiates execution of the compliance calculation and reminders program at Sunday morning. Reminders are sent to all patients that are non-compliant according to their preferential means of contact as entered in their registration information 617 of FIG. 6. Every Sunday morning at 1 am, the server program is started and the treatment instructions database server program enters the ‘Auto-Calc Compliance’ state 2360, and initiates execution of the compliance calculation and reminders program. In a preferred embodiment the compliance calculation and reminders program is executed once a week and compliance only considers those appointments more than one week old and for whom the practitioner has expressly requested the patients compliance be tracked; i.e. the TrackIt field of table PatCompliance 350 is set to ‘true’. These are parameterized settings and different setting can be utilized in a preferred embodiment. For instance, compliance calculation and reminder messages could be generated every evening rather than once a week.

In the exemplary system, all four states rely heavily on interaction with the exemplary treatment instruction database. The database may reside on the treatment server computer, or on another database server computer on the computer network.

The operator may terminate the execution or shutdown the treatment server database program in which case the program first transfers to the state ‘Logoff’ 2370 to normally shut-down the database and then transfer to the state ‘End’ 2380 to terminate the treatment server database program.

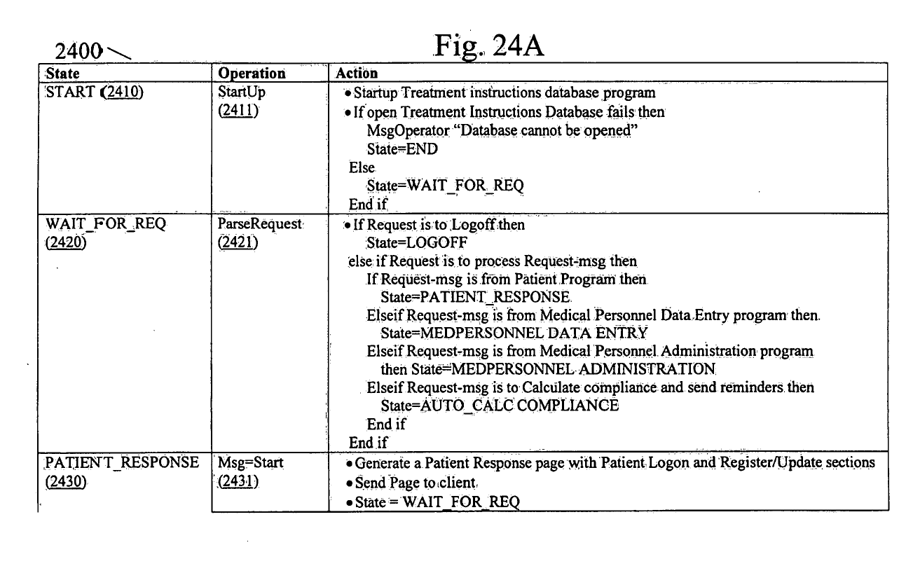

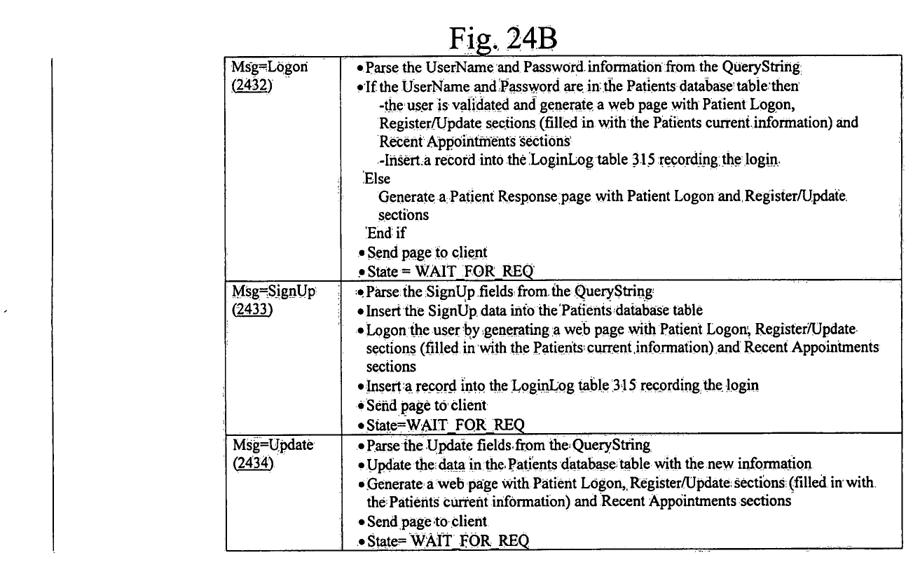

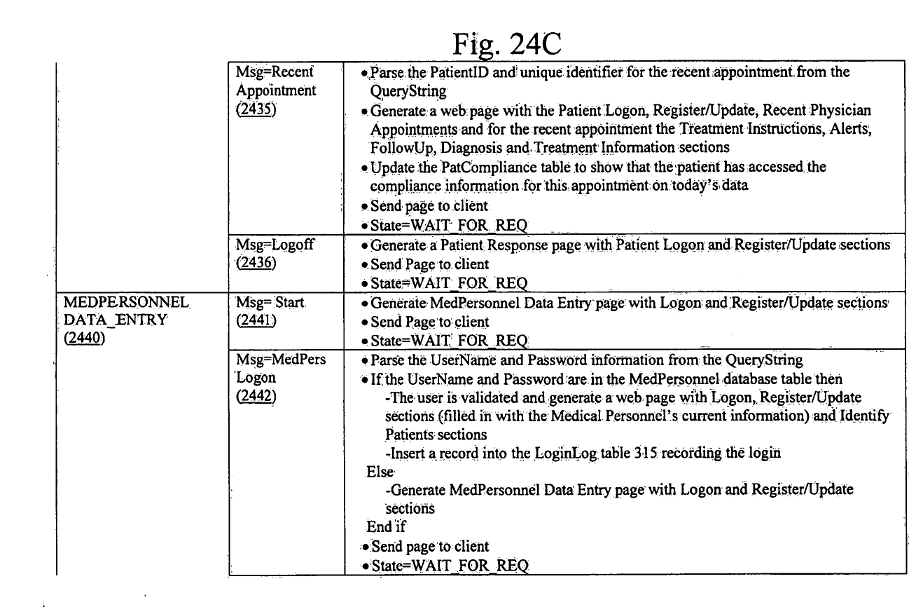

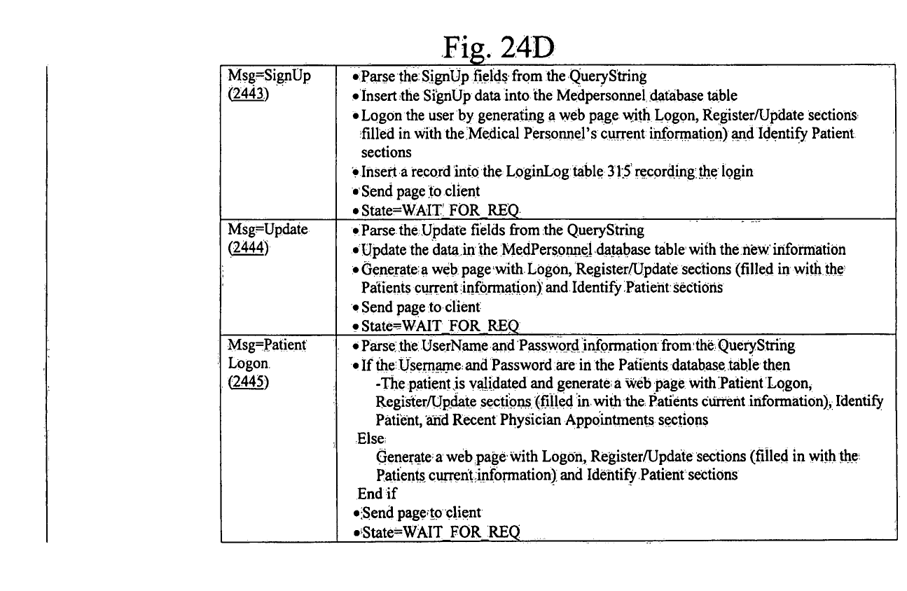

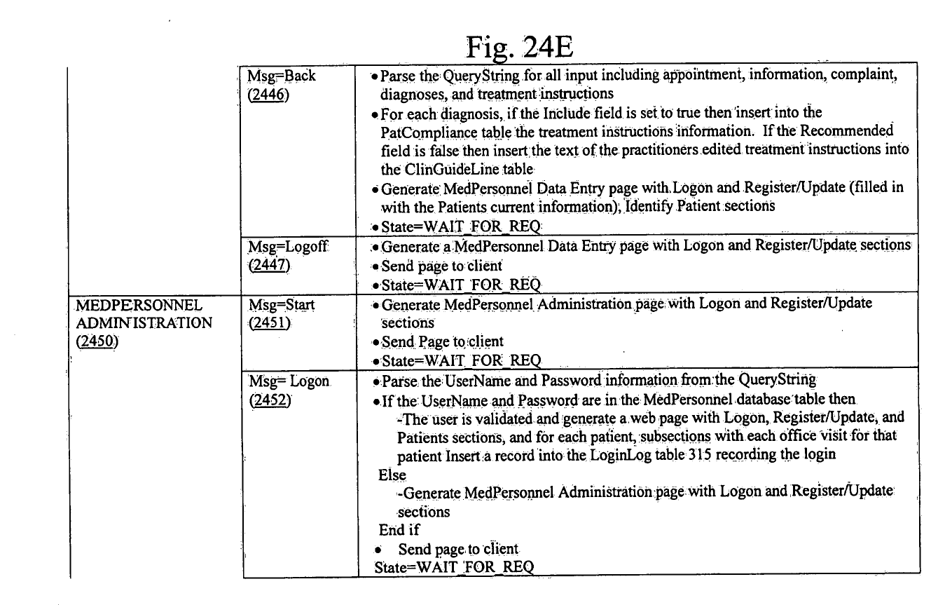

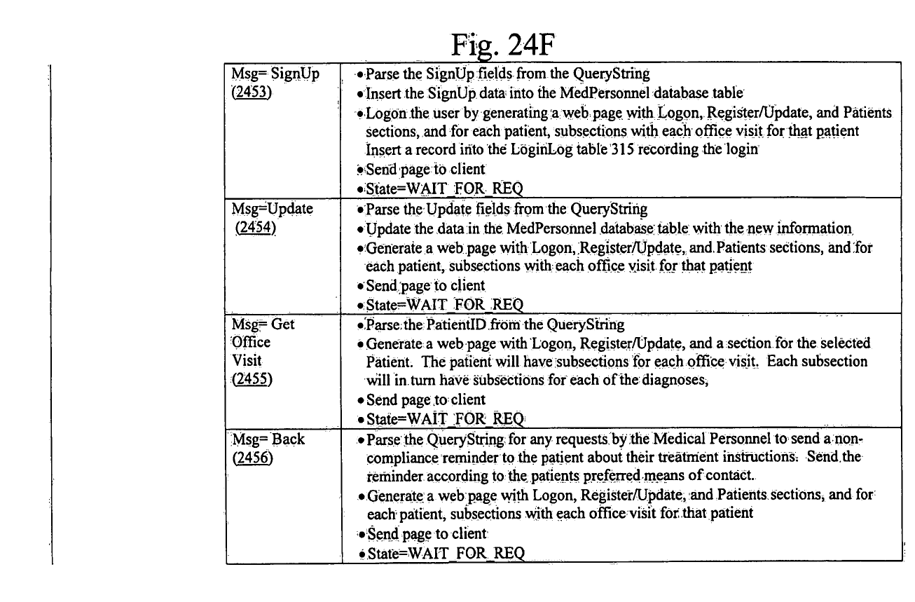

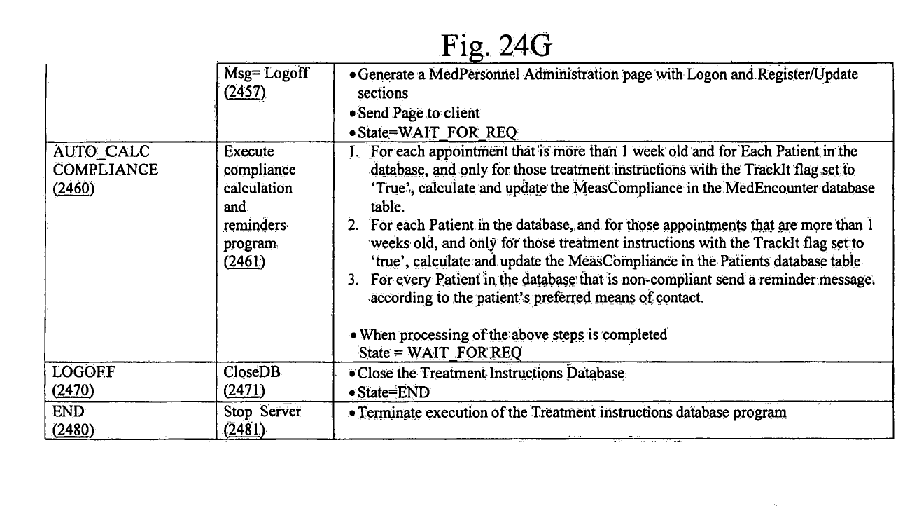

FIG. 24A, FIG. 24B, FIG. 24C, FIG. 24D, FIG. 24E, FIG. 24F, and FIG. 24G is a state table 2400 for the execution of the Treatment Instructions Database Server Program. It has 8 states, ‘START’ 2410 which corresponds to the state 2310 of FIG. 23; ‘WAIT_FOR_RESPONSE’ 2420 which corresponds to the state 2320 of FIG. 23; ‘PATIENT_RESPONSE’ 2430 which corresponds to the state ‘Patient Response’ 2330; ‘MEDPERSONNEL DATA_ENTRY’ 2440 which corresponds to the state 2340 of FIG. 23; ‘MEDPERSONNEL ADMINISTRATION’ 2450 which corresponds to the state 2350 of FIG. 23; ‘AUTO-CALC COMPLIANCE’ 246 which corresponds to the state 2360 of FIG. 23; ‘LOGOFF’ 2470 which corresponds to the state 2370 of FIG. 23, and ‘END’ 2480 which corresponds to state 2380 of FIG. 23. The state table provides more detail on the operation of the Treatment Instructions Database Server Program.

There is only one operation in state ‘START’ 2410, which is ‘StartUp’ 2411. In the exemplary system, an exemplary purpose of this state is to start the execution of the server program. The server program cannot be started if the database is unavailable, so immediately after starting execution the first operation that is performed is to open the treatment instructions database. If the treatment instructions database cannot be opened or is otherwise unavailable, then a message is sent to the operator that the ‘Database cannot be opened’ and immediately transfer to the state ‘END’ 2480 to terminate the execution of the program. If the treatment instructions database is available and can be opened then processing transitions to the state ‘WAIT_FOR_REQ’ 2420 to wait for service requests from client programs.

In the state ‘WAIT_FOR_REQ’ 2420, the server program idles, awaiting a network service request from one of the client programs. When it receives a network request it can determine which client has made the request from the http message body. An http message from the Exemplary patient program will reference the ASP exemplary patient program that processes the Exemplary patient program and transfer to the state ‘PATIENT_RESPONSE 2430; an http message from the Exemplary medical personnel data entry program will reference the ASP program that processes the Exemplary medical personnel data entry program and transfer to the state ‘MEDPERSONNEL DATA_ENTRY’ 2440, and an http message from the exemplary medical personnel administration program will reference the ASP program that processes the exemplary medical personnel administration program and transfer to the state ‘MEDPERSONNEL ADMINISTRATION’ 2450.

Within any of these states the processing will follow a similar pattern. First the QueryString of the message will be parsed to identify the type of message and user input. Then the ASP program will perform operations (SELECT, UPDATE, INSERT) with the treatment instructions database based on the user input, following which the ASP program will formulate the html page as a response to the client program. The response web page will be sent to the client, and finally the server will transfer back to the state ‘WAIT_FOR_REQ’ 2420.

In the state that processes client requests from the Exemplary patient program, ‘PATIENT_RESPONSE’ 2430, there are 6 possible operations or message requests. If the message request is to start a Patient session ‘Start’ 2431 then the processing will proceed by generating a response page with a Patient Logon, and Register/Update sections, sending the page to the client and then transfer to the state ‘WAIT_FOR_REQ’ 2420. This will only allow the patient to either register for the exemplary system or logon to the exemplary system with their registered Username and Password. If the message request is for a Patient Logon 2432 then the processing will proceed by parsing the Username and Password from the QueryString, and checking if the Username and Password are in the database table ‘Patients’ 305. If it is, then the user is validated, and the program inserts a record in the LoginLog table 315 recording the successful login, generates a response page with a Patient Logon, Register/Update screens and recent appointments sections. The Register/Update section will have all data fields filled in with the current information from the database. The patient is now logged onto the exemplary system will be able to view compliance information for their medical appointments.

In the exemplary system, even though the Patient has successfully logged into the exemplary system the Logon section is still generated. This is so another Patient may log into the exemplary system without having to start up a new browser session.

If the message request is for ‘SignUp’ 2433, then the Patient is requesting authorization to use the exemplary system. The server parses the QueryString for all the SignUp information and inserts the information into the ‘Patient’ Table of the exemplary treatment instruction database. The program inserts a record in the LoginLog table 315 recording the successful login, and then generates a response page with the Patient Logon, Register/Update and Recent Appointment sections, sends the page to the client and transfers to the state ‘WAIT_FOR_REQ’ 2420. The ‘Update’ message 2434 is handled similarly. The QueryString is parsed for the Update information and the Patient table of the exemplary treatment instruction database is updated with the information. The program then generates a response page with the Patient Logon, Register/Update and Recent Appointment sections, sends the page to the client and transfers to the state ‘WAIT_FOR_REQ’ 2420.

If the message request is for the Patient's recent appointments 2435 then the QueryString is parsed for the patient and appointment identification information. The patient, appointment, diagnosis, medical personnel, and patient compliance information are retrieved from the exemplary treatment instruction database and a response page is generated with sections for the Patient Logon, Register/Update, Recent Physician Appointments, and for the selected appointments treatment instructions, alerts, followup, diagnosis and treatment information. Before the page is returned to the client the ‘dateAccessed’ field of the PatCompliance table of the treatment instructions database is updated with current date for each of the compliance records for the requested medical encounter. The page is then sent to the client and processing continues in the state ‘WAIT_FOR_REQ’ 2420. If the message request is to ‘Logoff’ 2436 then the processing will proceed by generating a response page with a Patient Logon, and Register/Update sections, sending the page to the client and then transfer to the state ‘WAIT_FOR_REQ’ 2420. This has the effect of nullifying the patient's logon, as they cannot again view appointment or compliance specific information until they again use the logon function of the exemplary patient program.

In the state that processes client requests from the Exemplary medical personnel data entry program, ‘MEDPERSONNEL DATE_ENTRY’ 2440, there are 7 possible operations or message requests in the exemplary system. If the message request is to start a Medical Personnel Data Entry session ‘Start’ 2441 then the processing will proceed by generating a response page with a Logon, and Register/Update sections, and sending the page to the client and then transitioning to the state ‘WAIT_FOR_REQ’ 2420. If the message is a MedPersonnel Logon 2442, then the Username and Password are parsed from the QueryString and the program checks if the Medical Personnel is registered to use the exemplary system by checking the Username and Password in the MedPersonnel table 310 of the treatment instructions database. If the Username and Password are validated then processing will proceed by inserting a record in the LoginLog table 315 recording the successful login, generating a response page with a Logon, Register/Update and Identify Patients sections, sending the page to the client and then transitioning to the state ‘WAIT_FOR_REQ’ 2420.

If the message request is for ‘SignUp’ 2433, then in the exemplary system the Medical Personnel is requesting authorization to use the exemplary system. The server parses the QueryString for all the SignUp information and inserts the information into the ‘MedPersonnel’ Table 310 of the exemplary treatment instruction database. The program then inserts a record in the LoginLog table 315 recording the successful login, generates a response page with the Medical Personnel Logon, Register/Update and Identify Patients sections, sends the page to the client and transfers to the state ‘WAIT_FOR_REQ’ 2420. The ‘Update’ message 2444 is handled similarly. The QueryString is parsed for the Update information and the MedPersonnel table 310 of the exemplary treatment instruction database is updated with the information. The program then generates a response page with the Medical Personnel Logon, Register/Update and Identify Patients sections, sends the page to the client and transfers to the state ‘WAIT_FOR_REQ’ 2420.

If the message request is a Patient Logon 2445 then the program parses the QueryString for the Username and Med-Password or PIN of the patient. The Username and PIN are validated against the Patients Table, and if valid the program generates a response page with the Medical Personnel Logon, Register/Update, Identify Patients, and Recent Physician Appointment sections. If the Username and Pin cannot be validated in the database then the program generates a response page with the Medical Personnel Logon, Register/Update, and Identify Patients sections. The generated page is then sent to the client and the program transitions to the state ‘WAIT_FOR_REQ’ 2420.

If the message request is a ‘Save’ 2446 message then this indicates that the Medical Personnel have finished entering the information for the patient. The program parses the QuerySting for all appointment-related information including appointment date, diagnosis, complaint, and patient compliance information. The program updates the database with this information. For each diagnosis and for every type of treatment instructions, ‘Treatment instruction’ 1251, Diagnosis information 1252, ‘Treatment information’ 1253, ‘Followup’ 1254, and ‘Alerts’ 1255, if the ‘Include’ checkbox ‘1256’ is checked then the program will insert a record into the PatCompliance table of the exemplary treatment instruction database to reflect that this is treatment information specified by the medical practitioner. If the corresponding compliance tracking checkbox is selected 1257, then the TrackIt field of the PatCompliance field will be set to the value ‘Yes’ so the exemplary system will automatically monitor the patients usage and send compliance messages.

For each diagnosis the QueryString has a value for the hidden HTML field Recommended. This field has a value of ‘false’ if the medical personnel have in anyway edited or modified the recommended treatment guideline. If the value of the field is ‘true’ then the practitioner has accepted and is using the recommended treatment guidelines, and the treatment instructions for the encounter, patient and diagnosis use the ClinGuidelineID key in the primary-foreign key relationship between the ClinGuidelines table 340 and the PatCompliance table 350. If the value is ‘false’, then the practitioner has modified the recommended treatment guidelines and the values of each step of the treatment guideline are inserted into the ClinGuidelines table 340 of the treatment instructions database, and a new value for the index key ClinGuidelineID is generated and will be used in the primary-foreign key relationship with the PatCompliance table 350.

In the exemplary system, after the database has been updated, the exemplary system generates a response page with the Medical Personnel Logon, Register/Update, and Identify Patients sections and the program transitions to the state ‘WAIT_FOR_REQ’ 1240. The exemplary system is now ready for the Medical personnel to process the next patients' appointment.

If the response message is ‘Logoff’ 2447 then the Medical Personnel is finished using the data entry program. Processing proceeds by generating a response page with the Logon and Register/Update sections. The response page is sent back to the client and the program transitions to the state ‘WAIT_FOR_REQ’ 2420. This has the effect of nullifying the medical personnel's login, as they must login again to the exemplary system to use any of the data entry options.

In the state that processes client requests from the exemplary medical personnel administration program, ‘MEDPERSONNEL ADMINISTRATION’ 2450, there are 7 possible operations or message requests in the exemplary system. In the exemplary system, if the message request is to start a Medical Personnel Administration session ‘Start’ 2451 then the processing will proceed by generating a response page with a Medical Personnel Logon, and Register/Update sections, and sending the page to the client and then transfer to the state ‘WAIT_FOR_REQ’ 2420. If the message request is for a Medical Personnel Logon 2452 then the processing will proceed by parsing the Username and Password from the QueryString. If the Username and Password can be validated against the MedPersonnel table, then processing proceeds by inserting a record in the LoginLog table 315 recording the successful login, generating a response page with the Logon, Register/Update, and Patient sections. If the Username and Password cannot be validated then processing proceeds by generating a response page with the Logon and Register/Update sections. The response page is sent back to the client and the program transitions to the state ‘WAIT_FOR_REQ’ 2420. If a Patient section is generated it will have a section for every patient that has been seen by the Medical Personnel that is logged on, and each Patient section will in turn have a listing of all office visits by the patient with the medical personnel. Retrieving from the MedEncounter table 320 all appointments for each patient with the Medical Personnel that is logged onto the exemplary system generates the information in the Patient section.

If the message request is for ‘SignUp’ 2453, then in the exemplary system the Medical Personnel is requesting authorization to use the exemplary system. The server parses the QueryString for all the SignUp information and inserts the information into the ‘MedPersonnel’ Table of the exemplary treatment instruction database. The program then inserts a record in the LoginLog table 315 recording the successful login, generates a response page with the Medical Personnel Logon, Register/Update and Patient sections, sends the page to the client and transfers to the state ‘WAIT_FOR_REQ’ 2420. The ‘Update’ message 2454 is handled similarly. The QueryString is parsed for the Update information and the MedPersonnel table of the exemplary treatment instruction database is updated with the information. The program then generates a response page with the Medical Personnel Logon, Register/Update and Patients sections, sends the page to the client and transfers to the state ‘WAIT_FOR_REQ’ 2420.

In the exemplary system, if the message request is to ‘Get Office Visit 2455 then the Medical Personnel has requested to see the details of the compliance information for the patient. The QueryString is parsed for the identifier of the patient, and a response page is generated with Logon, Register/Update, and Patient sections. The patient section has subsections for each office visit, and each office visit has sections for each diagnosis. In this exemplary case the Patient section only has information for the single selected patient—not all patients as in the prior screens. The response page is sent to the client and the program transitions to the state ‘WAIT_FOR_REQ’ 1240 to wait on the next message request.

If the message request is ‘Back’ 2456, then in the exemplary system the Medical personnel is finished examining the detailed compliance information for a patient and the program returns to the same state displayed in FIG. 14. While medical personnel are examining the patients compliance information they may choose to instruct the exemplary system to send a compliance message to the patient. They do this by checking the ‘Send Reminder’ checkbox 1542 of FIG. 15. They may send reminder messages even for those treatment instructions that have not been flagged with a value of ‘true’ in the ‘TrackIt’ field of the PatCompliance Table 350. Processing proceeds by parsing the QueryString which will identify any treatment instructions that the medical personnel have requested compliance reminders be sent to the patient. If there are any then the exemplary system will invoke the procedures to send reminder messages according to the preference of the patient. For instance if the patients preference is to use Email then a MAPI component will be invoked by the server to send an Email message, similar to that in FIG. 16, to the patient. Processing continues by generating a response page with the Logon, Register/Update, and Patient sections, sending the response page to the user, and transitioning to the state ‘WAIT_FOR_REQ’ 2420.

If the response message is ‘Logoff’ 2457 then the Medical Personnel has finished using the administration program. Processing proceeds by generating a response page with the Logon and Register/Update sections. The response page is sent back to the client and the program transitions to the state ‘WAIT_FOR_REQ’ 2420.

A key feature of the exemplary system is its ability to identify patients that are non-compliant with treatment instructions and send them compliance reminders. This is implemented in a preferred embodiment by a server program that is executed Sunday each week at lam in the morning and calculates for every patient and for every patient session their measure of compliance. If a patient is non-compliant then a reminder message is sent to them.

When the exemplary system enters the ‘AUTO_CALC_COMPLIANCE’ state 2460, it performs a sequence of steps to calculate compliance according to the algorithm depicted in FIG. 4, and for non-compliant patients send reminder messages. Processing proceeds by first calculating according to the algorithm described in FIG. 4, and storing a measure of compliance for each appointment more than 2 weeks old and for each patient. The compliance measure is stored in the database in the MeasCompliance field for MedEncounter. Next a compliance measure is calculated for each patient in the database. In the exemplary system, this is done by considering only those appointments in the database more than 1 weeks old and calculating according to the algorithm described in FIG. 4 a measure of compliance and then updating the MeasCompliance field of the Patients Table with the value. The last step is to retrieve from the database the calculated measure of compliance for each patient and for those that are non-compliant sending them a reminder message, by means of their preferred means of contact, as stored in the PrefMeansContact field of the Patients Table. Compliance messages are only sent if there are items in the PatCompliance table with the field ‘TrackIt’ set to ‘true’ indicating that the Medical Personnel have specifically requested the exemplary system to track the Patients compliance for the respective information and send reminder messages. After the reminder messages have been processed, processing continues by transitioning to the state ‘WAIT_FOR_REQ’ 2420.

In the state ‘LOGOFF’ 2370 there is only one operation ‘CloseDB’ 2371 to finish and commit all transactions to the treatment instructions database and shutdown the database in a normal fashion. After the database is closed processing transitions to the state ‘End’ 2380, and the execution of the exemplary treatment instruction database server program is terminated.

Other embodiments of the inventions may use one or more of the same principles to implement a system for increasing a patient's compliance to medical care instructions. In a preferred embodiment medical compliance is measured by classifying a patients access to treatment information into one of 3 categories. In other embodiments, there may be more complicated algorithms to measure and classify patients into compliance groups. In the exemplary embodiment, non-compliant and partially compliant patients may be reminded to follow treatment instructions. In other embodiments, a multiplicity of means may be used to remind severely non-compliant patients to follow the treatment instructions.

In the present embodiment, once a patient accesses a treatment instruction source they are not subsequently issued reminders. In another embodiment, the user may be sent a reminder message in the case that the information is updated. For instance, in the case of drug alerts, if a new alert is issued, then the exemplary system can automatically determine which users are using that drug in treatment and send the new alert to them.

In still other embodiments the messaging and prompting of non-compliant or partially compliant patients to remind them about treatment instructions may be by other means including but not limited to mail, phone, beeper, or via cable TV.

A preferred embodiment uses a simple scheme to track patient compliance. If a patient accesses the medical appointment information from the exemplary patient program then they are assumed to be compliant. In other embodiments more complicated means may be used to measure compliance. For instance a preferred embodiment may measure the length of time that patients review a page, and rate as more compliant those patients that spend more time reviewing a page that those who spend less time reviewing a page. Also, in a preferred embodiment, the information about whether the patient has hyperlinked to recommended diagnosis and/or treatment information is preferably not captured. Other embodiments may capture that information and use it to calculate a patient's compliance. As an example, this could be implemented by one skilled in the art either by maintaining patient session information on the server in session specific variables, or by using hidden html fields to accumulate and store user interactions as the user views different web pages, by a combination of both, or by some other means known to those skilled in the art.

In the exemplary embodiment the list of diagnoses is contained within a single drop-down box with diagnoses identified by major and minor English language coding. In other embodiments of the invention, standard-coding definitions of diagnoses may be utilized.

In other embodiments compliance messages will be sent not just to the patient's medical practitioner but may also be sent to a supervisor and/or medical personnel who have a responsibility for compliance followup. In a preferred embodiment compliance is calculated and messages sent once each week. In other embodiments compliance may be calculated on a different schedule, and the algorithm for sending reminders may take into account when and whether prior reminder messages have been sent to the patient.

Other embodiments will be apparent to those skilled in the art from consideration of the specification and practice of the invention disclosed herein. It is intended that the specification and examples be considered as exemplary only, with a true scope of the invention being indicated by the following claims.

In the exemplary embodiment the Email address of the medical personnel is captured but is not made available in any fashion to the patient as a means to contact the practitioner. Other embodiments could provide functionality as part of the exemplary patient program to send Email to the practitioner.

What is claimed as new and desired to be protected by Letters Patent of the United States is:

1. An electronic medical records (EMR) apparatus comprising:
an EMR database comprising:
a patients table, operable to store personal data related to patients registered in the EMR apparatus;
a medical personnel table, operable to store data related to medical personnel registered in the EMR apparatus;
a medical encounter table, operable to store data related to medical encounters between a registered patient and registered medical personnel;
a patient-specific health condition table, operable to store data related to health conditions of a specific patient registered in the EMR apparatus;
a treatment instructions table, operable to store data related to specific instructions issued by medical personnel for at least one registered patient; and
a health condition resource information table, operable to store data related to resources directed to at least one health condition of at least one registered patient.

2. The EMR apparatus as recited in claim 1, wherein said EMR database further comprises:
a treatment resource information table, operable to store data related to resources directed to at least one treatment instruction of at least one registered patient; and
a user log table, operable to store data related to usage of the EMR system by registered users.

3. The EMR apparatus as recited in claim 1, wherein said EMR database further comprises:
a clinical practice guidelines table, operable to store data related to treatment guidelines pertinent to one or more health conditions; and
a general health condition table, operable to store data related to health conditions that apply generally to all patients.

4. The EMR apparatus as recited in claim 1, wherein said EMR database is a relational database, wherein at least one table of said database has a one-to-many relationship with other tables in said database, and wherein at least one table of said database is contained within another table of said database.

5. The EMR apparatus as recited in claim 1, further comprising:
an EMR processor, wherein said EMR processor controls operation of the EMR apparatus;
a patient client, wherein said patient client permits a registered patient to gain access to select data within said EMR database; and
a medical personnel client, wherein said medical personnel client permits medical personnel to gain access to data within said EMR database.

6. The EMR apparatus as recited in claim 5, wherein said EMR database further comprises a patient compliance table, operable to store data related to compliance by a patient as a result of a medical encounter, wherein said EMR processor determines a measure of patient compliance for a given registered patient, and wherein said medical personnel client permits viewing of patient compliance for any medical encounter of given registered patient.

7. The EMR apparatus as recited in claim 6, wherein said EMR processor determines a measure of patient compliance for a given registered patient based on access, by the given patient through a patient client, of data related to resources directed to at least one health condition of the given registered patient.

8. The EMR apparatus as recited in claim 6, wherein said EMR processor determines a measure of patient compliance for a given registered patient based on access by a patient client of treatment instructions stored in said EMR database that are associated with the given registered patient.

9. A method of using an electronic medical records (EMR) system, the method comprising:
a) forming an EMR database comprising:
a1) for at least one patient registered to use the EMR system, storing: patient identification data; patient password; and patient personal identification number (PIN);
a2) for at least one medical practitioner registered to use the EMR system, storing: medical personnel identification data; and medical personnel password;
a3) for at least one medical encounter between a patient and medical personnel, storing medical encounter data relating to the at least one medical encounter, wherein the medical encounter data includes information related to the at least one reason for the medical encounter, and at least one diagnosis by medical personnel corresponding to the medical encounter;
b) allowing access to the EMR database through a patient program, in which an authorized patient has access only to information related to the authorized patient, wherein the authorized patient is assigned a patient PIN in the EMR database for controlling access to information in the EMR database related to the patient; and
c) allowing access to the EMR database through a medical personnel data entry program, in which authorized medical personnel may access records related to a given patient only upon entry of input data corresponding to the patient PIN assigned to the given patient.

10. The method of using an electronic medical records (EMR) system as recited in claim 9, wherein said allowing access to the EMR database through a medical personnel data entry program further comprises, once accessing a given patient's records in the EMR database, allowing authorized medical personnel to enter diagnosis and treatment instructions for the given patient pursuant to a medical encounter.

11. The method of using an electronic medical records (EMR) system as recited in claim 9, said forming an EMR database further comprising storing informational guidelines related to at least one diagnosis stored in the EMR database, wherein said storing informational guidelines includes, storing as informational guidelines treatments compliant with industry standards of practice as related to the at least one diagnosis, storing as informational guidelines customized treatments related to the at least one diagnosis, and designating as a recommended treatment guideline one of a plurality of informational guidelines related to the at least one diagnosis; and
wherein, prior to entering treatment instructions for a given medical encounter using the medical personnel data entry program, displaying a recommended treatment guideline corresponding to the entered diagnosis for the given medical encounter, and adopting one of the following as treatment instructions for the given patient pursuant to a medical encounter: the recommended treatment guidelines, informational guidelines customized for the given patient, and a treatment regimen independent of any stored informational guidelines.

12. The method of using an electronic medical records (EMR) system as recited in claim 11, wherein said storing informational guidelines includes storing a hypertext link to an Internet resource, in which the Internet resource stores underlying text describing informational guidelines in the form of treatment guidelines, and wherein at least one of the stored informational guidelines has a plurality of steps identified by a sequence number to be followed in a specific sequence or temporal relationship.

13. The method of using an electronic medical records (EMR) system as recited in claim 9, said forming an EMR database further comprising storing compliance information related to at least one diagnosis associated with a given medical encounter stored in the EMR database.

14. The method of using an electronic medical records (EMR) system as recited in claim 13, wherein said forming an EMR database further comprises storing, for at least one diagnosis, patient compliance information related to specific treatment instructions issued to a patient and the status of patient compliance thereto.

15. The method of using an electronic medical records (EMR) system as recited in claim 9, wherein the EMR system is in a client-server network, in which the patient program resides on a client computer, and wherein said allowing access to the EMR database through a patient program further comprises:
displaying a list of medical encounters related to the authorized patient;
selecting for display treatment instructions for at least one of the listed medical encounters;
selecting for display a measure of compliance related to at least one set of treatment instructions; and
selecting for display a list of alerts informing the patient of symptoms for which the patient should seek immediate medical attention should the patient experience such symptoms.

16. The method of using an electronic medical records (EMR) system as recited in claim 9, wherein said allowing access to the EMR database through a patient program further comprises:
displaying diagnosis resource information listing resources containing information related to a patient's diagnosis, including Internet resources; and
displaying treatment resource information listing resources containing information related to a patient's treatment, including Internet resources.

17. The method of using an electronic medical records (EMR) system as recited in claim 9, wherein said allowing access to the EMR database through a medical entry program further comprises:
displaying a list of records for patients for which authorized medical personnel may review;
for a given listed patient, displaying a list of medical encounters; and
selecting for display compliance information for at least one medical encounter for the given listed patient.

18. The method of using an electronic medical records (EMR) system as recited in claim 9, further comprising:
logging at least one patient user accessing the EMR system to create an audit record, including a date and time of access of the system.

19. A method of using a patient client computer system, the method comprising the steps of:
gaining secured access to records of a given patient;
viewing at least one previous medical encounter of the given patient;
for the at least one previous medical encounter, viewing at least the following medical encounter data: complaint of the given patient; diagnosis for the complaint; and treatment instructions for the diagnosis; and
viewing resource information for at least one of the following: information related to the diagnosis; and information related to the treatment instructions.

20. The method of using a patient client computer system as claimed in claim 19, further comprising the step of viewing patient compliance information for the given patient, and wherein:
said step of gaining secured access comprises entry by a patient of its own username and password to gain access to its own individual patient records in an electronic medical records (EMR) database;
said step of viewing at least one previous medical encounter comprises viewing a plurality most recent doctor's office visits personally attended by the given patient; and
said step of viewing medical encounter data further comprises: viewing a date of the medical encounter; viewing an identity of a physician attending to the given patient during the medical encounter; viewing medication prescribed for the given patient; and viewing physician warnings and follow-up instructions.

21. The method of using a patient client computer system as claimed in claim 19, wherein said viewing resource information includes links to Internet resources for both diagnosis and treatment information.

22. The method of using a patient client computer system as claimed in claim 19, further comprising the steps of:
customizing display of information;
restricting access to personal data of the given patient.

23. An article of manufacture comprising at least one machine-readable storage medium having stored therein indicia of a plurality of machine-executable control program steps, the control program comprising the steps of:
a) storing patient data, including patient identification data, and patient password;
b) storing medical encounter data relating to at least one medical encounter between a medical personnel and a patient, wherein the medical encounter data includes at least one reason for the medical encounter, and at least one diagnosis by medical personnel corresponding to the medical encounter; and
c) storing medical condition data relating to at least one medical condition that may be deemed by medical personnel to relate to a patient as a result of a medical encounter, wherein medical condition data includes general information about a given medical condition.

24. The article of manufacture as recited in claim 23, the control program further comprising the steps of:
(d) storing treatment information for at least one medical encounter of a given patient;
(e) determining compliance by the given patient with the treatment information stored in said storing step (d) for a given medical encounter; and
(f) issuing a notification based on a determination of non-compliance in said determining step (e).

25. The article of manufacture as recited in claim 24, wherein:
said storing step (b) includes storing data regarding: a medical encounter in the form of a doctor's office visit, medical personnel in the form of a doctor who examined the patient during the office visit, and a patient complaint as a reason for the office visit;
the treatment information in said storing step (d) includes medication regimen issued by the doctor who examined the given patient during a given office visit; and
said issuing step (f) includes issuing a notification in the form of a reminder message sent to the given patient to comply with the medication regimen issued by the doctor.
